(19) United States
(12) Patent Application Publication
(10) Pub. No.: US 2019/0156253 A1
(43) Pub. Date: May 23, 2019

(54) AUTOMATICALLY GENERATING VOLUME FORECASTS FOR DIFFERENT HIERARCHICAL LEVELS VIA MACHINE LEARNING MODELS

(71) Applicant: United Parcel Service of America, Inc., Atlanta, GA (US)

(72) Inventors: Collette Malyack, Atlanta, GA (US); Ted Abebe, Jersey City, NJ (US); Donald Hickey, Atlanta, GA (US); Ed Hojecki, Atlanta, GA (US); I. Lavrik, Atlanta, GA (US); Vinay Rao, Wayne, NJ (US)

(21) Appl. No.: 16/197,093

(22) Filed: Nov. 20, 2018

Related U.S. Application Data
(60) Provisional application No. 62/589,818, filed on Nov. 22, 2017.

(51) Int. Cl. G06Q 10/04; G06Q 10/08; G06N 20/00; G06F 17/18; G06N 5/02

(52) U.S. Cl. CPC G06Q 10/04; G06Q 10/0838; G06N 5/022; G06N 20/00; G06F 17/18; G06Q 10/0833

(57) ABSTRACT

Embodiments are disclosed for autonomously generating volume forecasts. An example method includes accessing volume information units from a volume forecast data management tool. The example method further includes extracting features from volume information units, wherein the features are representative of one or more of a package received time, or package information. The features can be categorized by different hierarchical level information. The example method further includes generating, using a volume forecast learning model and the features, an output comprising a volume forecast for a particular hierarchical level. Corresponding apparatuses and non-transitory computer readable storage media are also provided.

### CROSS-REFERENCE TO RELATED APPLICATIONS

This application claims priority to U.S. Provisional Patent Application No. 62/589,818 entitled “SYSTEMS AND METHODS FOR AUTOMATICALLY GENERATING VOLUME FORECASTS FOR DIFFERENT HIERARCHICAL LEVELS USING MACHINE LEARNING MODELS,” filed Nov. 22, 2017, which is incorporated herein by reference in its entirety.

### FIELD

The present disclosure relates to machine learning technology and data volume forecasting technology, and more particularly, to extracting gathered volume forecast data and utilizing machine learning models to generate a volume forecast.

### BACKGROUND

When parcels (e.g., packages, containers, letters, items, pallets or the like) are received from shippers and transported from an origin to a destination, the process of transporting the packages may include moving the packages through various intermediate locations between its origin and destination, such as sorting operation facilities. Processing and sorting at these facilities may include various actions, such as culling where parcels are separated according to shape or other characteristics, capturing information from the parcel to retrieve shipping information (e.g., tracking number, destination address, etc.), organizing the parcels according to a shipment destination, and loading the parcels into a delivery vehicle. Efficiently allocating resources throughout the chain of delivery can be improved by accurately predicting volume forecast information (e.g., a particular quantity of parcels that will be received) for some or each leg of the transportation process.

Existing volume forecasting technologies are typically based on simple threshold-based calculation and require users to manually input various sets of information into computer systems to process shipments. For example, particular volume forecasting software applications require users to manually set the prediction parameters (e.g., how many packages will be needed on a given day) based on personal observation, such as viewing a spreadsheet to view pending shipments. In response to the manual entry in these computer systems, a display screen is configured to display the prediction for other users to view to adequately prepare for the prediction. Some technologies make simple forecasts and responsively make adjustments. For example, a volume forecast may take into account only raw numbers, such as predicting that there will be a first quantity of packages that will arrive in the next few days based only on the quantity of shipments that are pending and are set to arrive on a particular day. Embodiments of the present disclosure improve these existing computer systems by overcoming various shortcomings, as described herein.

### SUMMARY

Example embodiments described herein comprise systems that autonomously generates volume forecasts. The details of some embodiments of the subject matter described in this specification are set forth in the accompanying drawings and the description below. Other features, aspects, and advantages of the subject matter will become apparent from the description, the drawings, and the claims. Various embodiments describe an apparatus, a method, and a non-transitory computer readable storage medium for autonomously generating volume forecast.

In some aspects, the apparatus for autonomously generating a volume forecast includes a volume forecasting engine configured to perform the following example operations. One or more volume information units are accessed from a volume forecast data management tool. The one or more volume information units comprise volume forecast data. The volume forecast data comprises one or more of a package received time and package information. One or more features are extracted from the volume information units. The features are representative of one or more of the package received time or the package information. Using a volume forecast learning model and the one or more features, an output comprising a volume forecast for a particular hierarchical level is generated.

In some aspects, the method for autonomously generating volume forecast includes the following example operations. Using a volume forecasting engine, one or more volume information units are accessed from a volume forecast data management tool. The one or more volume information units comprise volume forecast data. The volume forecast data comprises one or more of package received time and package information. Using the volume forecasting engine, one or more features are extracted from the volume information units. The features are representative of one or more of the package received time or the package information. Using a volume forecast learning model and the one or more features, an output comprising a volume forecast for a particular hierarchical level is generated.

In some aspects, the non-transitory computer readable storage medium stores computer-readable program instructions that, when executed, cause a computer to perform the following example operations. One or more volume forecast data associated with one or more parcels are accessed. The volume forecast data includes one or more of: parcel received time, manifest package time, tracking number, package activity time stamp, package dimension information, package weight, package manifested weight, package manifest time stamp, package service type, package scanned time stamp, package tracking number, package sort type code, package scanned code, unit load device type code, and account number associated with the one or more parcels. The one or more volume forecast data are fed through at least one volume forecast learning model. Based at least in part on the feeding of the one or more volume forecast data through the at least one volume forecast learning model, a first quantity of parcels that will arrive at a destination for a particular time period are predicted at a particular hierarchical level. The hierarchical level being a category of generated volume forecast.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF FIGS

Having thus described the disclosure in general terms, reference will now be made to the accompanying drawings, which are not necessarily drawn to scale, and wherein:

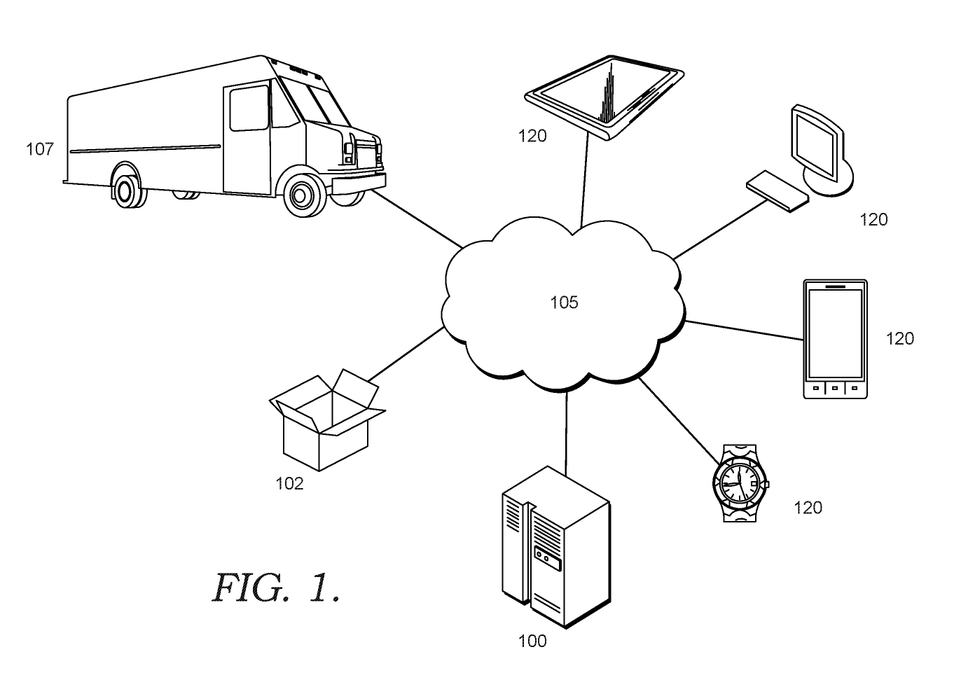

FIG. 1 is a schematic diagram of an example computing environment in which aspects of the present disclosure are employed in, according to some embodiments;

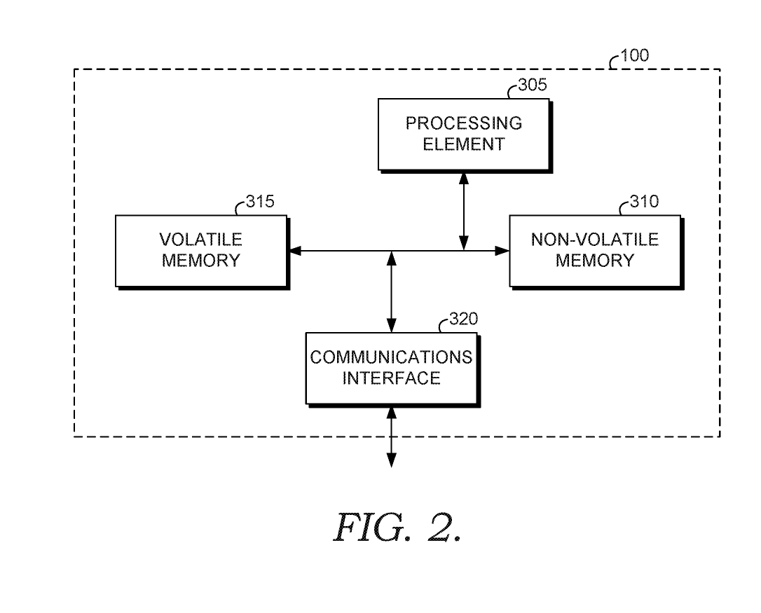

FIG. 2 provides a schematic of a volume forecast entity according to one embodiment of the present disclosure, according to some embodiments;

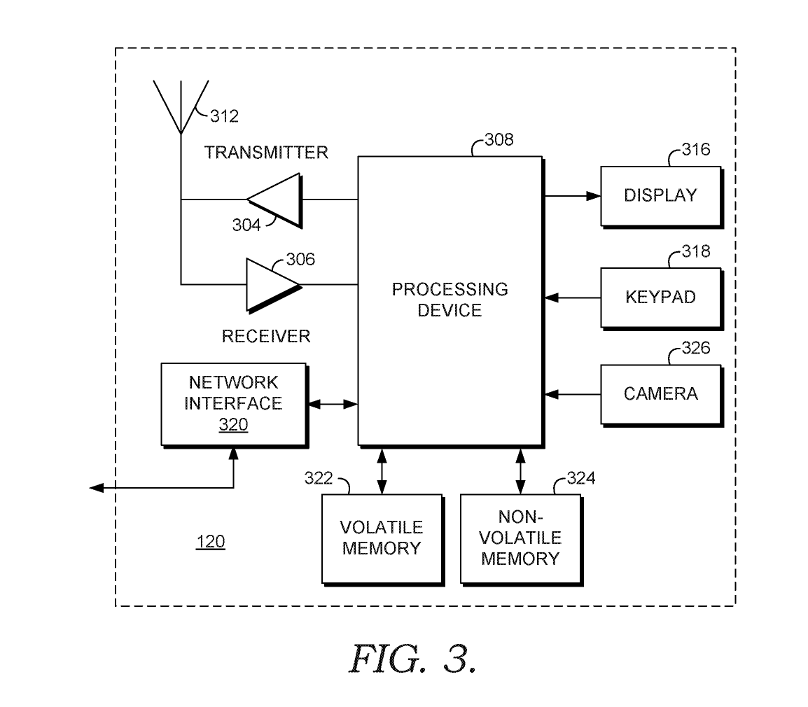

FIG. 3 provides an illustrative schematic representation of a mobile computing entity 120 that can be used in conjunction with embodiments of the present disclosure, according to some embodiments;

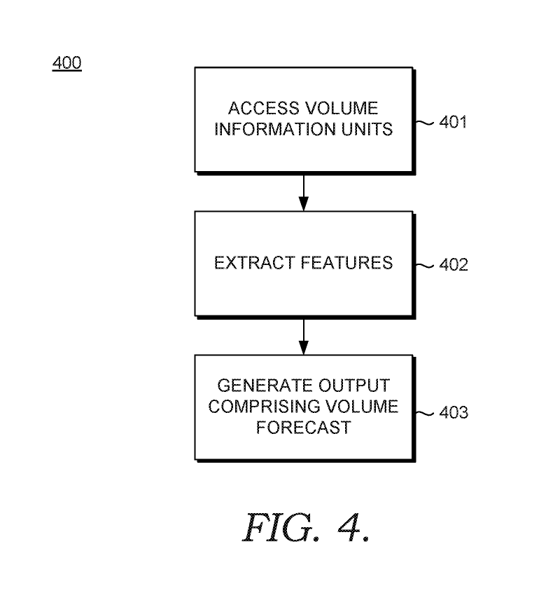

FIG. 4 illustrates an exemplary process for use with embodiments of the present disclosure;

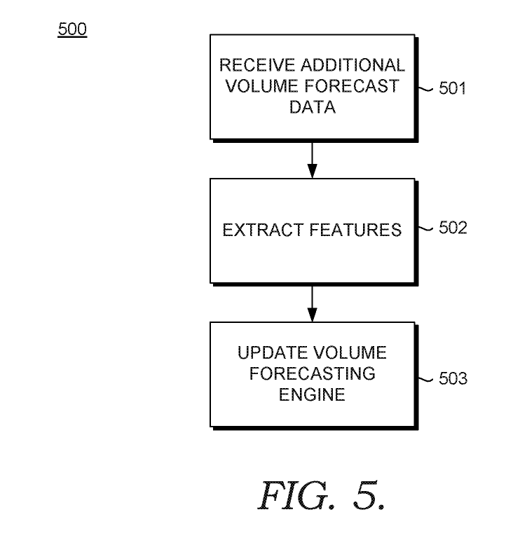

FIG. 5 illustrates an exemplary process for use with embodiments of the present disclosure;

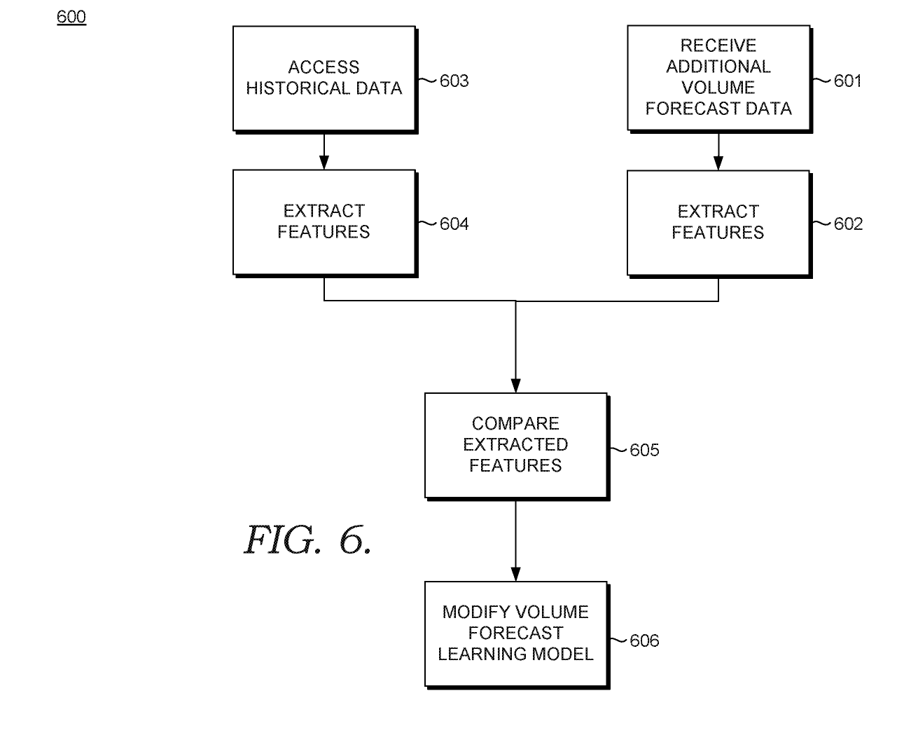

FIG. 6 illustrates an exemplary process for use with embodiments of the present disclosure;

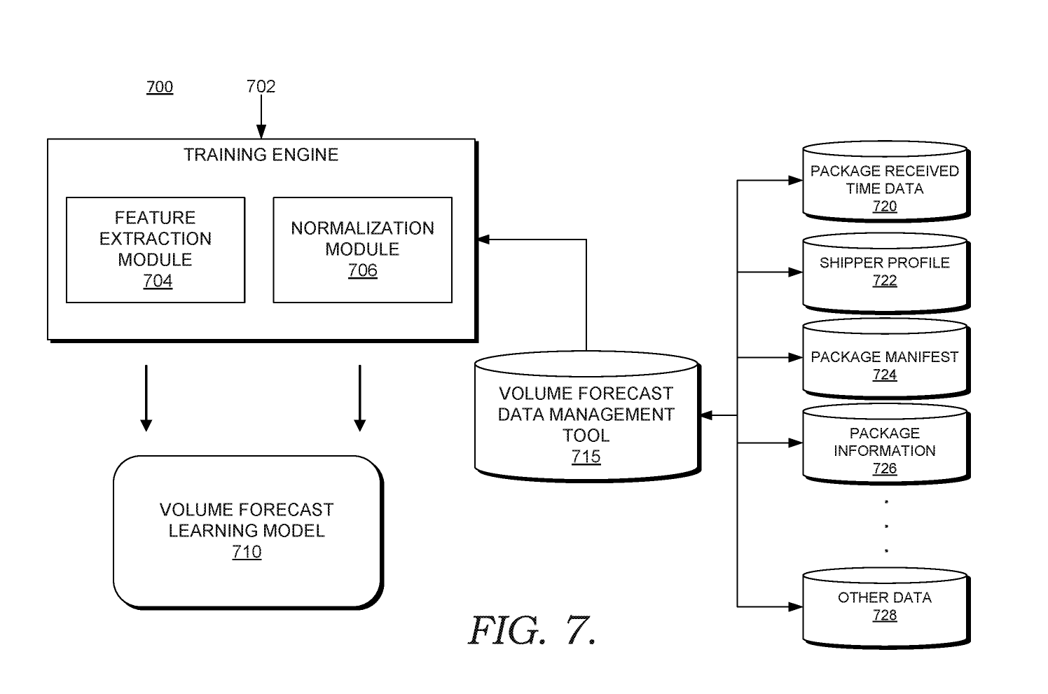

FIG. 7 is an example block diagram of the components of an example volume forecast learning model training environment; and

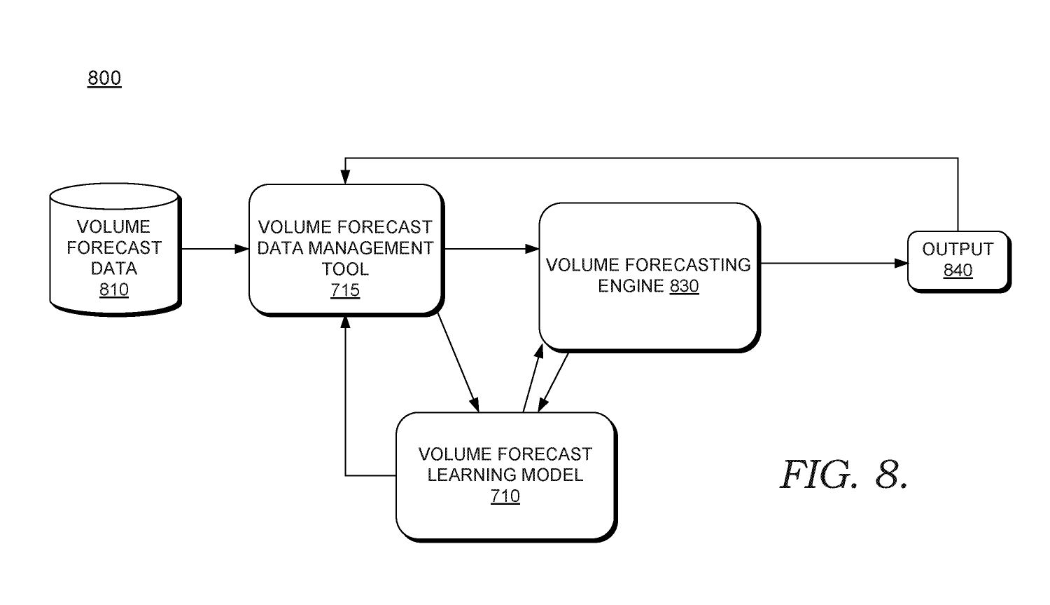

FIG. 8 is an example block diagram of the components of an example volume forecast learning model service environment.

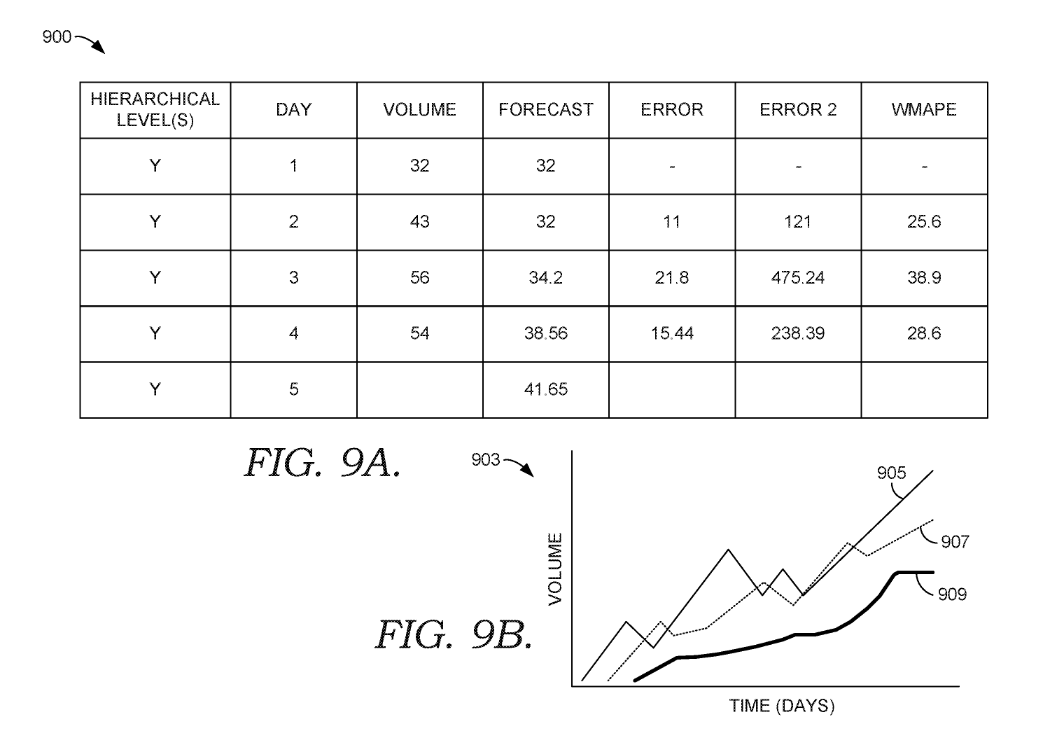

FIG. 9A is a schematic diagram of an example exponential smoothing forecast model table, according to some embodiments.

FIG. 9B is a schematic diagram of an example time series graph associated with the exponential smoothing forecast model table of FIG. 9A.

### DETAILED DESCRIPTION

The present disclosure will now be described more fully hereinafter with reference to the accompanying drawings, in which some, but not all embodiments of the disclosure are shown. Indeed, the disclosure may be embodied in many different forms and should not be construed as limited to the embodiments set forth herein. Rather, these embodiments are provided so that this disclosure will satisfy applicable legal requirements. Like numbers refer to like elements throughout.

### I. Overview

Existing computing system technologies employ functionality that generates forecasts based on simple threshold-based calculations. For example, existing technologies may predict that there will be 1,000 packages coming into one facility in the next five days, but does not output hierarchical level information such as the service types of the packages that will be received, what times during the day the packages will be received, etc. Knowledge of only the total volume is not useful, even if it is accurate, because one cannot efficiently allocate resources (e.g., provide specific personnel to handle the specific service types) based on volume forecasts that are not specifically geared toward each hierarchical level.

Existing computing system technologies also employ functionality that require users to manually input information, such as forecasting information. For example, users may be required to manually enter several values from a package manifest into an electronic spreadsheet application, which then does simple threshold-based calculations after the user enters in the several values. Moreover, a user may manually enter actual forecast or prediction values into a computer system based on personal observation. However, not only does this waste valuable time, but various computing resources are unnecessarily consumed. For example, repetitive clicks, selections, or manual data entry in these systems increase storage device I/O (e.g., excess physical read/write head movements on non-volatile disk). This is because each time a user inputs this information, the computing system has to traverse a network and reach out to a storage device to perform a read or write operation. This is time consuming, error prone, and can eventually wear on components, such as a read/write head. Reaching out to disk is also very expensive because of the address location identification time and mechanical movements required of a read/write head. Further, when users repetitively issue queries, it is expensive because processing multiple queries consume a lot of computing resources. For example, an optimizer engine of a database manager module calculates a query execution plan (e.g., calculates cardinality, selectivity, etc.) each time a query to locate staff details (e.g., work shift, who is available to work, etc.) is issued to make forecasting predictions. This requires a database manager to find the least expensive query execution plan to fully execute the query. Most database relations contain hundreds if not thousands of records. Repetitively calculating query execution plans on this quantity of records decreases throughput and increases network latency. Moreover, manual data entry is particularly tedious and can be error prone. For example, in various instances users input the wrong information, which causes errors.

Various embodiments of the present disclosure improve these existing computer technologies via new functionalities that these existing technologies or computing systems do not now employ. For example, various embodiments of the present disclosure improve the accuracy of volume forecasts by generating volume forecasts at multiple different hierarchical levels to thereby enable more targeted predictive resource allocation. As described above, typical volume forecasts do not generate volume forecasts at hierarchical levels leading to an inability to allocate resources (e.g., provide extra staff on a particular day because of a staffing shortage on a particular day). Through applied effort, ingenuity, and innovation, this and other problems have been solved by embodiments of the present disclosure, many examples of which are described in detail herein. By accessing one or more volume information units or volume forecast data (e.g., parcel received time, manifest package time, dimension information, etc.), feeding this information through a volume forecast learning model, and responsively making a prediction (e.g., predicting that a first quantity of parcels will arrive at a destination at a particular time), the improved computer systems in particular embodiments are able to more fully and accurately make predictions associated with shipments, as described in more detail herein (e.g., FIG. 4 through FIG. 9).

Some embodiments also improve existing software technologies by automating tasks (e.g., automatically accessing data and automatically predicting or making volume forecasts) via certain rules (e.g., X quantity of package manifests or other data has been received). As described above, such tasks are not automated in various existing technologies and have only been historically performed by manual computer input by humans. In particular embodiments, incorporating these certain rules improve existing technological processes by allowing the automation of these certain tasks, which is described in more detail below.

Various embodiments improve resource consumption in computing systems (e.g., disk I/O). Particular embodiments selectively exclude or do not require a request for a user to manually enter information, such as carrier personnel entering prediction values based on personal observation of package manifests. Because users do not have to keep manually entering information or selections, storage device I/O is reduced and query optimizers are not as often utilized, which allows for a reduction in computing query execution plans and thus increased throughput and decreased network latency. For example in particular embodiments, as soon as package manifest information is received from a user, some or each of the information in the package manifest information is parsed and written to disk a single time (as opposed to multiple times for each set of information) when it is fed through learning models and predictions are made. Accordingly, the disk read/write head in various embodiments reduces the quantity of times it has to go to disk to write records, which may reduce the likelihood of read/write errors and breakage of the read/write head.

### II. Computer Program Products, Methods, and Computing Entities

Embodiments of the present disclosure may be implemented in various ways, including as computer program products that comprise articles of manufacture. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double information/data rate synchronous dynamic random access memory (DDR SDRAM), double information/data rate type two synchronous dynamic random access memory (DDR2 SDRAM), double information/data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices/entities, computing entities, and/or the like. As such, embodiments of the present disclosure may take the form of an apparatus, system, computing device, computing entity, and/or the like executing instructions stored on a computer-readable storage medium to perform certain steps or operations. However, embodiments of the present disclosure may also take the form of an entirely hardware embodiment performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices/entities, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### III. Example Definitions

As used herein, the terms “data,” “content,” “digital content,” “digital content object,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices/entities, such as, for example, one or more servers, relays, routers, network access points, base stations, hosts, and/or the like, sometimes referred to herein as a “network.” Similarly, where a computing device is described herein to transmit data to another computing device, it will be appreciated that the data may be sent directly to another computing device or may be sent indirectly via one or more intermediary computing devices/entities, such as, for example, one or more servers, relays, routers, network access points, base stations, hosts, and/or the like.

The terms “package”, “parcel, “item,” and/or “shipment” refer to any tangible and/or physical object, such as a wrapped package, a container, a load, a crate, items banded together, an envelope, suitcases, vehicle parts, pallets, drums, vehicles, and the like sent through a delivery service from a first geographical location (e.g., a first home/business address) to one or more other geographical locations (e.g., a second home/business address).

The term “carrier” and/or “shipping service provider” (used interchangeably) refer to a traditional or nontraditional carrier/shipping service provider. A carrier/shipping service provider may be a traditional carrier/shipping service provider, such as United Parcel Service (UPS), FedEx, DHL, courier services, the United States Postal Service (USPS), Canadian Post, freight companies (e.g. truck-load, less-than-truckload, rail carriers, air carriers, ocean carriers, etc.), and/or the like. A carrier/shipping service provider may also be a nontraditional carrier/shipping service provider, such as Amazon, Google, Uber, ride-sharing services, crowd-sourcing services, retailers, and/or the like.

The term “volume forecast data” refers to data of interest for generating volume forecast. In some embodiments, the volume forecast data comprises one or more package received time (e.g., the actual time one or more packages are received at a sorting operation facility), manifest package time, package information such as tracking number, package activity time stamp, package dimension including height, length and/or width, package weight, package manifested weight (e.g., the weight of a parcel as indicated in a package manifest), package manifest time stamp (e.g., the time at which a package manifest is uploaded), package service type, package scanned time stamp (e.g., the time at which a parcel was scanned to capture parcel information data), package tracking number, package sort type code, package scanned code (e.g., a barcode), unit load device type code, account number associated with the package, and the like. In some embodiments, volume forecast data may be received, over a computer network, from vehicles and/or mobile computing entities. A “unit load device type code” identifies an entity type in which one or more parcels are loaded into for delivery, such as a container, a delivery vehicle, a bag, a pallet, etc.

The term “volume forecast data management tool” refers to a management tool that collects, analyzes, and/or manages volume forecast data. The volume forecast data may be provided over a computer network and to the volume forecast data management tool by one or more different service points (e.g., lockers, carrier stores, retailers, etc.), vehicles, mobile computing entities, and/or any other electronic devices that gather volume forecast data. Alternatively or in addition, the volume forecast data management tool may receive volume forecast data directly from a distributed computing entity (e.g., a cloud computing node in a cloud computing environment). In some embodiments, the volume forecast data management tool is embedded within a volume forecast entity (e.g., the volume forecast entity 100).

The term “volume information units” refers to a set of data that has been normalized (e.g., via Z-score, min max, etc.) and/or parsed within a larger pool of volume forecast data. The process of parsing the volume forecast data may comprise selectively copying or extracting specific volume forecast data based on the tuning of a volume forecast learning model (e.g., specific input information required of a volume forecast learning model). To selectively copy or extract volume forecast data means that only some data is extracted or copied from the volume forecast data to be fed through a learning model, while another set of data is not extracted or copied and is not fed through a learning model. For instance, in some embodiments, a person's name in manifest package information is not extracted because the volume forecast data would not necessarily be needed by the volume forecast learning model. However, other information, such as manifest weight, dimensions, etc. would be used to make predictions. The volume information units in such instances refer to the subset of volume forecast data that does not contain those certain elements of the volume forecast data, and the parsing and normalization process eliminates those certain elements prior to the remaining data being fed into the volume forecast learning model.

The term “feature” refers to data generated based on or from volume information units and subsequently fed into a machine learning model. In some embodiments, the features are equivalent to volume information units (i.e., they are the same). Alternatively or in addition, the features can be generated by other techniques, such as classifying or categorizing information. For example, if the volume information unit comprises “manifest time: 9:00 am; received time: 10:04 am; package weight: 30 lb”, the features generated can correspond to a classification of each of the elements present in the volume information unit in the form of “manifest time: morning; received time: morning; package weight: heavy.” Accordingly, the features would be “morning, morning, and heavy” for the specific corresponding values. In some embodiments, one feature may be generated based on multiple volume information units (e.g., that were received over a particular period time). For example, package received time for multiple occasions (e.g., within several package manifests) can be used to generate one feature. In this way the volume forecasting engine can receive various information units, analyze them, and map or categorize them to a feature. For example, a volume forecasting engine may use volume information units that represents package manifest time and package received time in the past two days and generate a feature called “total number of packages received early morning in the past two days”.

The term “package manifest” refers to a report (e.g., a digital document) provided by a shipper to a shipping service provider that summarizes the shipment information about one or more parcels that the shipper is going to provide to the shipping service provider. A package manifest may include one or more of: the shipper's account information, shipping record identifier, dimensions of the package to be picked up, a planned package pick up time, a package pick up location, package weight, tracking number, manifest time stamp (e.g., day of week, month, week, and/or hour that manifest is uploaded), service type code, the like. A package manifest may include any of the information described in the present disclosure.

The term “manifest package time” refers to the planned package pick up time (e.g., by a carrier) and/or planned drop off time (e.g., by a shipper to a carrier) as indicated in the package manifest. For example, a shipper may request that a shipping service provider send a driver to pick up a package at a certain location (manifest package location) at a manifest package time by selecting or inputting the time in a manifest package time field of the package manifest.

The term “package timeliness” refers to a shipper's timeliness in providing the shipper's package to a shipping service provider in relation to the manifest package time. In some embodiments, package timeliness is based on one or more predefined rules. For example, a shipper may indicate that the shipper is going to provide a package to the service provider on 2:00 pm on Thursday, and if the shipper provides the shipping service provider with the package at 2:00 pm on Thursday, then the shipper would be categorized as a “timely shipper” with respect to that package because the shipper provided the package by 2:00 p.m. In another example, providing the package within a certain window (i.e. a predetermined rule) before or after 2:00 pm on Thursday would still result in the shipper being categorized as a timely shipper. However, if the shipper provides the package late according to a predetermined rule (e.g., 20 minutes after 2:00 p.m.), the shipper would be categorized as a “late shipper” in some embodiments. And if the shipper provides the package early according to another predetermine rule (e.g., 20 minutes before 2:00 p.m.), then the shipper would be categorized as an “early shipper” in some embodiments.

The term “package received time” refers to the actual time where the package is received by a shipping service provider or carrier from a shipper. For example, the package received time may be when carrier personnel at a shipping store print out a label for a package that a shipper has brought to the shipping store.

The term “indicator” refers to data that indicates one or more attributes. For example, a residential indicator indicates whether a package is being sent to residential address, a hazardous material indicator indicates whether a package contains hazardous material, an oversize indicator indicates whether a package is oversized, a document indicator indicates whether a package is a document, and a Saturday delivery indicator indicates whether a package is planned to be delivered on a Saturday. In some embodiments, indicators are generated in response to receiving and analyzing information in one or more package manifests and mapping the indicator to an attribute (e.g., via a hash table).

The term “package activity time stamp” refers to a time stamp generated based on the time-stamp data acquired when performing one or more package activities. Package activity time stamps are indicative of times (e.g., clock-times) at which one or more parcels are received and/or transmitted to/from one or more locations. For example, a package time activity time stamp may be one or more of the following: a time stamp generated when the package is received from the shipper, a time stamp generated when the package is sent from a receiving site (e.g., a sorting facility) to an intermediate transmit vehicle (e.g., an airplane), a time stamp generated when the package is sent from an intermediate transmit vehicle to another vehicle (e.g., the vehicle 107), and the like.

The term “building type” refers to the categorization of a building operated by a shipping service provider. For example, buildings may be categorized by size, average inbound and/or outbound volume, location, purpose of the building (intermediate transit or stores facing customers, etc.), and the like.

The term “service type” or “package service type” refers to the categorization of the service provided associated with the package. For example, service type may be categorized by delivery speed, return receipt requested, insurance associated with the package, originating location, destination location, and the like. Exemplary service types include “Next Day Air”, “2^{nd} day Air”, “Worldwide Express”, “Standard”, and the like. In some embodiments, the service type is input or selected within the package manifest by a shipper.

The term “sort type” or “package sort type code” refers to the categorization of time in hours/minutes of package received time. An exemplary way of defining sort type is provided as the following:

Package receive between 10:00 pm and 5:00 am: Sort type “Late night”;

Package receive between 5:00 am and 8:00 am: Sort type “Early Morning”;

Package receive between 8:00 am and 2:00 pm: Sort type “Morning to early afternoon”;

Package receive between 2:00 pm and 10:00 am: Sort type “Afternoon to Night”.

Packages can be categorized by sort types defined using different names and different defined time period. Each defined category is called a “sort”. In some embodiments, sorts are generated in response to receiving and analyzing information in one or more package manifests and mapping package received times to the sort type (e.g., via a data structure). In some embodiments, sorts are generated in response to running package manifest information through a learning model.

The term “account type” refers to the categorization of the shipper account associated with a package. For example, account type may be categorized by whether the shipper is a personal shipper or a business shipper, by the frequency with which the shipper provides packages, by the service type requested, or by other shipping information associated with an account of the shipper. The shipping information may be processed before being used to categorize account type. For example, if a personal shipper ships ten packages per month, a server may first process the shipping information associated with the ten packages and generate an indicator of frequency of shipping for the shipper, then categorize the shipper's account type as “frequent—personal shipper”. In some embodiments, account types are generated in response to receiving and analyzing information in one or more package manifests and mapping information to an account type. In some embodiments, sorts are generated in response to running package manifest information through a learning model.

The term “hierarchical level” refers to a categorization of information, such as one or more categories of a generated volume forecast. In various embodiments, a hierarchical level is a specific attribute among a plurality of attributes for which a particular predicted quantity of parcels or volume will be received for. In these cases, particular prediction values are made for specific attributes only and not made for other attributes or do not include the same values. For example, a volume forecast can be generated for the hierarchical level of “account plus building,” which means that the volume forecast reflects package volume associated with a certain type of account (such as a personal shipper account, as opposed to business accounts) at a particular building (such as an operational facility at 123 Fictional Street, as opposed to any other address). Hierarchical levels can reflect or be one or more of: an account type, a service type, a building type, a sort type, a building identifier (such as a building address or ID code), a package weight category, a package dimension category, other categorizations of packages, a shipper, a set of facilities in the shipping process, and/or the like. Volume forecasts can be generated at each hierarchical level among a plurality of hierarchical levels where values of one or more of the hierarchical levels are different. In some embodiments, volume forecasts are generated at a certain hierarchical level by extracting features for that certain hierarchical level. For example, if a volume forecast at the hierarchal level of a building plus sort is desired (e.g., a package volume forecast for a particular building during the early morning), the features extracted may reflect previous package information at the particular building and sort type. In an additional example illustration of a “hierarchical level,” a package weight of 5-10 pounds can be a first hierarchical level and a package weight of 11-15 pounds is a second hierarchical level. Accordingly, if package manifest information from over 10 shipments revealed a first quantity of shipments that fell between the first hierarchical level and a second quantity of shipments fell between the second hierarchical level, there may be a predicted quantity for future shipments for the first hierarchical level (any future shipments between 5-10 pounds) based on the first quantity and not the second quantity. In this manner and in various embodiments, the second hierarchical level and its associated second quantity is not taken into consideration for future shipments that fall between 5-10 pounds.

The term “hierarchical level information” refers to information describing a hierarchical level. Hierarchical level information identifies a class of entities addressed by the volume forecast, the class of entities comprising entities having properties associating them with a particular account type, service type, building type, sort type, building identifier, package weight category, package dimension category, other categorizations of packages, shipper, or facilities in the shipping process. Example of other categorizations of packages, shipper or facilities are: facility location code, facility purpose (directly providing service to shippers such as a UPS store, or intermediary transit sites), building size, package categorized by different indicators defined in terms section, and the like.

The term “volume forecast learning model” refers to a machine learning model that uses features generated from volume information units to generate volume forecasts.

A “machine learning model” or “learning model” as described herein refers to a model that is used for machine learning tasks or operations. A machine learning model can comprise a title and encompass one or more input images or data, target variables, layers, classifiers, etc. In various embodiments, a machine learning model can receive an input (e.g., package manifest information and/or actual processed information (e.g., actual received date, etc.)), and based on the input identify patterns or associations in order to predict a given output (e.g., predict that a specific quantity of packages will be received for a particular hierarchical level, such as hour). Machine learning models can be or include any suitable model, such as one or more: neural networks, word2Vec models, Bayesian networks, Random Forests, Boosted Trees, etc. “Machine learning” as described herein, in particular embodiments, corresponds to algorithms that parse or extract features of historical data (e.g., package manifests/past shipments), learn (e.g., via training) about the historical data by making observations or identifying patterns in data, and then receive a subsequent input (e.g., a current package manifest) in order to make a determination, prediction, and/or classification of the subsequent input based on the learning without relying on rules-based programming (e.g., conditional statement rules).

### III. Example System Architecture

FIG. 1 is a schematic diagram of an example computing environment in which aspects of the present disclosure are employed in, according to some embodiments. As shown in FIG. 1, this particular embodiment may include one or more volume forecast entities 100 that each comprise a volume forecasting engine, one or more package/items/shipments 102, one or more networks 105, one or more vehicles 107, one or more mobile computing entities 120, and/or the like. Each of these components, entities, devices, systems, and similar words used herein interchangeably may be in direct or indirect communication with, for example, one another over the same or different wired or wireless networks. Additionally, while FIG. 1 illustrates the various system entities as separate, standalone entities, the various embodiments are not limited to this particular architecture. It is understood that while the computing environment of FIG. 1 includes specific components, some components may be added to the environment (one or more additional nodes on a distributed computing system), while other components are not necessarily present (e.g., the vehicle 107).

### 1. Exemplary Volume Forecast Entity

FIG. 2 provides a schematic of a volume forecast entity 100 according to one embodiment of the present invention. The volume forecast entity 100 may comprise volume forecast data management tool and volume forecasting engine among other modules. In certain embodiments, the volume forecast entity 100 may be maintained by and/or accessible by a carrier. A carrier may be a traditional carrier, such as United Parcel Service (UPS), FedEx, DHL, courier services, the United States Postal Service (USPS), Canadian Post, freight companies (e.g. truck-load, less-than-truckload, rail carriers, air carriers, ocean carriers, etc.), and/or the like. However, a carrier may also be a nontraditional carrier, such as Amazon, Google, Uber, ride-sharing services, crowd-sourcing services, retailers, and/or the like. In general, the terms computing entity, computer, entity, device, system, and/or similar words used herein interchangeably may refer to, for example, one or more computers, computing entities, desktops, mobile phones, tablets, phablets, notebooks, laptops, distributed systems, gaming consoles (e.g., Xbox, Play Station, Wii), watches, glasses, iBeacons, proximity beacons, key fobs, radio frequency identification (RFID) tags, ear pieces, scanners, televisions, dongles, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the volume forecast entity 100 may also include one or more communications interfaces 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the volume forecast entity 100 may include or be in communication with one or more processing elements 305 (also referred to as processors, processing circuitry, processing devices, and/or similar terms used herein interchangeably) that communicate with other elements within the volume forecast entity 100 via a bus, for example. As will be understood, the processing element 305 may be embodied in a number of different ways. For example, the processing element 305 may be embodied as one or more complex programmable logic devices (CPLDs), microprocessors, multi-core processors, coprocessing entities, application-specific instruction-set processors (ASIPs), microcontrollers, and/or controllers. Further, the processing element 305 may be embodied as one or more other processing devices or circuitry. The term circuitry may refer to an entirely hardware embodiment or a combination of hardware and computer program products. Thus, the processing element 305 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 305 may be configured for a particular use or configured to execute instructions stored in volatile or non-volatile media or otherwise accessible to the processing element 305. As such, whether configured by hardware or computer program products, or by a combination thereof, the processing element 305 may be capable of performing steps or operations according to embodiments of the present invention when configured accordingly. For example, processing element may be configured to perform various functionality of a volume forecasting engine, such as

In one embodiment, the volume forecast entity 100 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 310, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The terms database, database instance, database management system, and/or similar terms used herein interchangeably may refer to a structured collection of records or data that is stored in a computer-readable storage medium, such as via a relational database, hierarchical database, hierarchical database model, network model, relational model, entity-relationship model, object model, document model, semantic model, graph model, and/or the like.

In one embodiment, the volume forecast entity 100 may further include or be in communication with volatile media (also referred to as volatile storage, memory, memory storage, memory circuitry and/or similar terms used herein interchangeably). In one embodiment, the volatile storage or memory may also include one or more volatile storage or memory media 215, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 305. Thus, the databases, database instances, database management systems, data, applications, programs, program modules, scripts, source code, object code, byte code, compiled code, interpreted code, machine code, executable instructions, and/or the like may be used to control certain aspects of the operation of the volume forecast entity 100 with the assistance of the processing element 305 and operating system.

As indicated, in one embodiment, the volume forecast entity 100 may also include one or more communications interfaces 320 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the volume forecast entity 100 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra wideband (UWB), infrared (IR) protocols, near field communication (NFC) protocols, Bluetooth protocols, Wibree, Home Radio Frequency (HomeRF), Simple Wireless Abstract Protocol (SWAP), wireless universal serial bus (USB) protocols, and/or any other wireless protocol.

Although not shown, the volume forecast entity 100 may include or be in communication with one or more input elements, such as a keyboard input, a mouse input, a touch screen/display input, motion input, movement input, audio input, pointing device input, joystick input, keypad input, and/or the like. The volume forecast entity 100 may also include or be in communication with one or more output elements (not shown), such as audio output, video output, screen/display output, motion output, movement output, and/or the like.

In some embodiments, processing element 305, non-volatile memory 310 and volatile memory 315 may be configured to support a volume forecasting engine. For example, processing element 305 may be configured to execute operations that comprise the volume forecasting engine, and non-volatile memory 310 and volatile memory 315 may be configured. to store computer code executed by the processing element 305, as well as to store relevant intermediate or ultimate results produced from execution of the volume forecasting engine.

In some embodiments, processing element 305, non-volatile memory 310 and volatile memory 315 may be configured to support a volume forecast data management tool. For example, processing element 305 may be configured to execute operations that comprise the volume forecast data management tool, and non-volatile memory 310 and volatile memory 315 may be configured. to store computer code executed by the processing element 305, as well as to store relevant intermediate or ultimate results produced from execution of the volume forecast data management tool.

As will be appreciated, one or more of the volume forecast entity's 100 components may be located remotely from other volume forecast entity 100 components, such as in a distributed system. Furthermore, one or more of the components may be combined and additional components performing functions described herein may be included in the volume forecast entity 100. Thus, the volume forecast entity 100 can be adapted to accommodate a variety of needs and circumstances. As will be recognized, these architectures and descriptions are provided for exemplary purposes only and are not limited to the various embodiments.

### 2. Exemplary Vehicle

In various embodiments, the term vehicle 107 is used generically. For example, a carrier/transporter vehicle 107 may be a manned or unmanned tractor, a truck, a car, a motorcycle, a moped, a Segway, a bicycle, a golf cart, a hand truck, a cart, a trailer, a tractor and trailer combination, a van, a flatbed truck, a vehicle, an unmanned aerial vehicle (UAV) (e.g., a drone), an airplane, a helicopter, a boat, a barge, and/or any other form of object for moving or transporting people and/or package/items/shipments (e.g., one or more packages, parcels, bags, containers, loads, crates, items banded together, vehicle parts, pallets, drums, the like, and/or similar words used herein interchangeably). In one embodiment, each vehicle 107 may be associated with a unique vehicle identifier (such as a vehicle ID) that uniquely identifies the vehicle 107. The unique vehicle ID (e.g., trailer ID, tractor ID, vehicle ID, and/or the like) may include characters, such as numbers, letters, symbols, and/or the like. For example, an alpha, numeric, or alphanumeric vehicle ID (e.g., “AS”) may be associated with each vehicle 107. In another embodiment, the unique vehicle ID may be the license plate, registration number, or other identifying information/data assigned to the vehicle 107. As noted above, in instances where the vehicle is a carrier vehicle, the vehicle may be a self-driving delivery vehicle or the like. Thus, for the purpose of the present disclosure, the term driver of a delivery vehicle may be used to refer to a carrier personnel who drives a delivery vehicle and/or delivers package/items/shipments therefrom, an autonomous system configured to deliver package/items/shipments (e.g., a robot configured to transport package/items/shipments from a vehicle to a service point such as a customer's front door or other service point), and/or the like.

Various computing entities, devices, and/or similar words used herein interchangeably can be associated with the vehicle 107, such as a data collection device or other computing entities. In general, the terms computing entity, entity, device, system, and/or similar words used herein interchangeably may refer to, for example, one or more computers, computing entities, desktops, mobile phones, tablets, phablets, notebooks, laptops, distributed systems, gaming consoles (e.g., Xbox, Play Station, Wii), watches, glasses, iBeacons, proximity beacons, key fobs, RFID tags, ear pieces, scanners, televisions, dongles, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. In various embodiments, a data collection device (not shown) located within or on the vehicle 107 collects telematics information/data (including GPS location information/data, such as geo coordinates (e.g., latitude, longitude) and transmit/send the information/data to an onboard computing entity, a distributed computing entity, and/or various other computing entities via one of several communication methods.

In one embodiment, the data collection device may include, be associated with, or be in wired or wireless communication with one or more processors (various exemplary processors are described in greater detail below), one or more location-determining devices or one or more location sensors (e.g., Global Navigation Satellite System (GNSS) sensors), one or more telematics sensors, one or more real-time clocks, a J-Bus protocol architecture, one or more electronic control modules (ECM), one or more communication ports for receiving telematics information/data from various sensors (e.g., via a CAN-bus), one or more communication ports for transmitting/sending information/data, one or more RFID tags/sensors, one or more power sources, one or more data radios for communication with a variety of communication networks, one or more memory modules 410, and one or more programmable logic controllers (PLC). It should be noted that many of these components may be located in the vehicle 107 but external to the data collection device.

In one embodiment, the one or more location sensors, modules, or similar words used herein interchangeably may be one of several components in wired or wireless communication with or available to the data collection device. Moreover, the one or more location sensors may be compatible with GPS satellites, such as Low Earth Orbit (LEO) satellite systems, Department of Defense (DOD) satellite systems, the European Union Galileo positioning systems, Global Navigation Satellite systems (GLONASS), the Chinese Compass navigation systems, Indian Regional Navigational satellite systems, and/or the like. Furthermore, the one or more location sensors may be compatible with Assisted GPS (A-GPS) for quick time to first fix and jump start the ability of the location sensors to acquire location almanac and ephemeris data, and/or be compatible with Satellite Based Augmentation System (SBAS) such as Wide Area Augmentation System (WAAS), European Geostationary Navigation Overlay Service (EGNOS), and/or MTSAT Satellite Augmentation System (MSAS), GPS Aided GEO Augmented Navigation (GAGAN) to increase GPS accuracy. This information/data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, triangulation may be used in connection with a device associated with a particular vehicle 107 and/or the vehicle's operator and with various communication points (e.g., cellular towers or Wi-Fi access points) positioned at various locations throughout a geographic area to monitor the location of the vehicle 107 and/or its operator. The one or more location sensors may be used to receive latitude, longitude, altitude, heading or direction, geocode, course, position, time, and/or speed data (e.g., referred to herein as telematics information/data and further described herein below). The one or more location sensors may also communicate with the volume forecast entity, the data collection device, distributed computing entity, m computing entity, and/or similar computing entities.

As indicated, in addition to the one or more location sensors, the data collection device may include and/or be associated with one or more telematics sensors, modules, and/or similar words used herein interchangeably. For example, the telematics sensors may include vehicle sensors, such as engine, fuel, odometer, hubometer, tire pressure, location, weight, emissions, door, and speed sensors. The telematics information/data may include, but is not limited to, speed data, emissions data, RPM data, tire pressure data, oil pressure data, seat belt usage data, distance data, fuel data, idle data, and/or the like (e.g., referred to herein as telematics information/data). The telematics sensors may include environmental sensors, such as air quality sensors, temperature sensors, and/or the like. Thus, the telematics information/data may also include carbon monoxide (CO), nitrogen oxides (NOx), sulfur oxides (SOx), Ethylene Oxide (EtO), ozone (O₃), hydrogen sulfide (H₂S) and/or ammonium (NH₄) data, and/or meteorological data (e.g., referred to herein as telematics information/data).

In one embodiment, the ECM may be one of several components in communication with and/or available to the data collection device. The ECM, which may be a scalable and subservient device to the data collection device, may have data processing capability to decode and store analog and digital inputs from vehicle systems and sensors. The ECM may further have data processing capability to collect and present telematics information/data to the J-Bus (which may allow transmission to the data collection device), and output standard vehicle diagnostic codes when received from a vehicle's J-Bus-compatible on-board controllers 440 and/or sensors.

As indicated, a communication port may be one of several components available in the data collection device (or be in or as a separate computing entity). Embodiments of the communication port may include an Infrared Data Association (IrDA) communication port, a data radio, and/or a serial port. The communication port may receive instructions for the data collection device. These instructions may be specific to the vehicle 107 in which the data collection device is installed, specific to the geographic area in which the vehicle 107 will be traveling, specific to the function the vehicle 107 serves within a fleet, and/or the like. In one embodiment, the data radio may be configured to communicate in accordance with multiple wireless communication standards and protocols, such as UMTS, CDMA2000, 1×RTT, WCDMA, TD-SCDMA, LTE, E-UTRAN, EVDO, HSPA, HSDPA, Wi-Fi, WiMAX, UWB, IR, NFC, Bluetooth, USB, Wibree, HomeRF, SWAP, and/or the like.

### 3. Exemplary Package/Item/Shipment

A package/item/shipment 102 may be any tangible and/or physical object. Such items/shipments 102 may be picked up and/or delivered by a carrier/transporter. In one embodiment, an package/item/shipment 102 may be or be enclosed in one or more packages, parcels, bags, containers, loads, crates, items banded together, vehicle parts, pallets, drums, the like, and/or similar words used herein interchangeably. Such items/shipments 102 may include the ability to communicate (e.g., via a chip (e.g., an integrated circuit chip), RFID, NFC, Bluetooth, Wi-Fi, and any other suitable communication techniques, standards, or protocols) with one another and/or communicate with various computing entities for a variety of purposes. For example, the package/item/shipment 102 may be configured to communicate with a mobile computing entity 120 using a short/long range communication technology, as described in more detail below. Further, such package/items/shipments 102 may have the capabilities and components of the described with regard to the volume forecast entities 100, networks 105, vehicles 107, mobile computing entities 120, and/or the like. For example, the package/item/shipment 102 may be configured to store package/item/shipment information/data. In example embodiments, the package/item/shipment information/data may comprise one or more of a consignee name/identifier, an package/item/shipment identifier, a service point (e.g., delivery location/address, pick-up location/address), instructions for delivering the package/item/shipment, and/or the like. In this regard, in some example embodiments, a package/item/shipment may communicate send “to” address information/data, received “from” address information/data, unique identifier codes, and/or various other information/data. In one embodiment, each package/item/shipment may include a package/item/shipment identifier, such as an alphanumeric identifier. Such package/item/shipment identifiers may be represented as text, barcodes, tags, character strings, Aztec Codes, MaxiCodes, Data Matrices, Quick Response (QR) Codes, electronic representations, and/or the like. A unique package/item/shipment identifier (e.g., 123456789) may be used by the carrier to identify and track the package/item/shipment as it moves through the carrier's transportation network. Further, such package/item/shipment identifiers can be affixed to items/shipments by, for example, using a sticker (e.g., label) with the unique package/item/shipment identifier printed thereon (in human and/or machine readable form) or an RFID tag with the unique package/item/shipment identifier stored therein.

In various embodiments, the package/item/shipment information/data comprises identifying information/data corresponding to the package/item/shipment. The identifying information/data may comprise information/data identifying the unique package/item/shipment identifier associated with the package/item/shipment. Accordingly, upon providing the identifying information/data to the package/item/shipment detail database (may be embedded in distribution computing entity), the package/item/shipment detail database may query the stored package/item/shipment profiles to retrieve the package/item/shipment profile corresponding to the provided unique identifier.

Moreover, the package/item/shipment information/data may comprise shipping information/data for the package/item/shipment. For example, the shipping information/data may identify an origin location (e.g., an origin serviceable point), a destination location (e.g., a destination serviceable point), a service level (e.g., Next Day Air, Overnight, Express, Next Day Air Early AM, Next Day Air Saver, Jetline, Sprintline, Secureline, 2nd Day Air, Priority, 2nd Day Air Early AM, 3 Day Select, Ground, Standard, First Class, Media Mail, SurePost, Freight, and/or the like), whether a delivery confirmation signature is required, and/or the like. In certain embodiments, at least a portion of the shipping information/data may be utilized as identifying information/data to identify a package/item/shipment. For example, a destination location may be utilized to query the package/item/shipment detail database to retrieve data about the package/item/shipment.

In certain embodiments, the package/item/shipment information/data comprises characteristic information/data identifying package/item/shipment characteristics. For example, the characteristic information/data may identify dimensions of the package/item/shipment (e.g., length, width, height), a weight of the package/item/shipment, contents of the package/item/shipment, and/or the like. In certain embodiments, the contents of the package/item/shipment may comprise a precise listing of the contents of the package/item/shipment (e.g., three widgets) and/or the contents may identify whether the package/item/shipment contains any hazardous materials (e.g., the contents may indicate whether the package/item/shipment contains one or more of the following: no hazardous materials, toxic materials, flammable materials, pressurized materials, controlled substances, firearms, and/or the like).

### 4. Exemplary Mobile Computing Entity

Mobile computing entities 120 may be configured for autonomous operation and/or for operation by a user (e.g., a vehicle operator, delivery personnel, customer, and/or the like). In certain embodiments, mobile computing entities 120 may be embodied as handheld computing entities, such as mobile phones, tablets, personal digital assistants, and/or the like, that may be operated at least in part based on user input received from a user via an input mechanism. Moreover, mobile computing entities 120 may be embodied as onboard vehicle computing entities, such as central vehicle electronic control units (ECUs), onboard multimedia system, and/or the like that may be operated at least in part based on user input. Such onboard vehicle computing entities may be configured for autonomous and/or nearly autonomous operation however, as they may be embodied as onboard control systems for autonomous or semi-autonomous vehicles, such as unmanned aerial vehicles (UAVs), robots, and/or the like. As a specific example, mobile computing entities 120 may be utilized as onboard controllers for UAVs configured for picking-up and/or delivering packages to various locations, and accordingly such mobile computing entities 120 may be configured to monitor various inputs (e.g., from various sensors) and generated various outputs (e.g., control instructions received by various vehicle drive mechanisms). It should be understood that various embodiments of the present disclosure may comprise a plurality of mobile computing entities 120 embodied in one or more forms (e.g., handheld mobile computing entities 120, vehicle-mounted mobile computing entities 120, and/or autonomous mobile computing entities 120).

As will be recognized, a user may be an individual, a family, a company, an organization, an entity, a department within an organization, a representative of an organization and/or person, and/or the like—whether or not associated with a carrier. In one embodiment, a user may operate a mobile computing entity 120 that may include one or more components that are functionally similar to those of the volume forecast entities 100. FIG. 3 provides an illustrative schematic representative of a mobile computing entity 120 that can be used in conjunction with embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, vehicle multimedia systems, autonomous vehicle onboard control systems, watches, glasses, key fobs, radio frequency identification (RFID) tags, ear pieces, scanners, imaging devices/cameras (e.g., part of a multi-view image capture system), wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Mobile computing entities 120 can be operated by various parties, including carrier personnel (sorters, loaders, delivery drivers, network administrators, and/or the like). As shown in FIG. 3, the mobile computing entity 120 can include an antenna 312, a transmitter 304 (e.g., radio), a receiver 306 (e.g., radio), and a processing element 305 (e.g., CPLDs, microprocessors, multi-core processors, coprocessing entities, ASIPs, microcontrollers, and/or controllers) that provides signals to and receives signals from the transmitter 304 and receiver 306, respectively.

The signals provided to and received from the transmitter 304 and the receiver 306, respectively, may include signaling information in accordance with air interface standards of applicable wireless systems. In this regard, the mobile computing entity 120 may be capable of operating with one or more air interface standards, communication protocols, modulation types, and access types. More particularly, the mobile computing entity 120 may operate in accordance with any of a number of wireless communication standards and protocols, such as those described above with regard to the volume forecast entities 100. In a particular embodiment, the mobile computing entity 120 may operate in accordance with multiple wireless communication standards and protocols, such as UMTS, CDMA2000, 1×RTT, WCDMA, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the mobile computing entity 120 may operate in accordance with multiple wired communication standards and protocols, such as those described above with regard to the volume forecast entities 100 via a network interface 320.

Via these communication standards and protocols, the mobile computing entity 120 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The mobile computing entity 120 can also download changes, add-ons, and updates, for instance, to its firmware, software (e.g., including executable instructions, applications, program modules), and operating system.

According to one embodiment, the mobile computing entity 120 may include location determining aspects, devices, modules, functionalities, and/or similar words used herein interchangeably. For example, the mobile computing entity 120 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire information/data, sometimes known as ephemeris information/data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This information/data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information can be determined by triangulating the mobile computing entity's 120 position in connection with a variety of other systems, including cellular towers, Wi-Fi access points, and/or the like. Similarly, the mobile computing entity 120 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices/entities (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The mobile computing entity 120 may also comprise a user interface (that can include a display 316 coupled to a processing element 305) and/or a user input interface (coupled to a processing element 305). For example, the user interface may be a user application, browser, user interface, and/or similar words used herein interchangeably executing on and/or accessible via the mobile computing entity 120 to interact with and/or cause display of information from the volume forecast entities 100, as described herein. The user input interface can comprise any of a number of devices or interfaces allowing the mobile computing entity 120 to receive information/data, such as a keypad 318 (hard or soft), a touch display, voice/speech or motion interfaces, or other input device. In some embodiments including a keypad 318, the keypad 318 can include (or cause display of) the conventional numeric (0-9) and related keys (#, *), and other keys used for operating the mobile computing entity 120 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

As shown in FIG. 3, the mobile computing entity 120 may also include an camera, imaging device, and/or similar words used herein interchangeably 326 (e.g., still-image camera, video camera, IoT enabled camera, IoT module with a low resolution camera, a wireless enabled MCU, and/or the like) configured to capture images. The mobile computing entity 120 may be configured to capture images via the onboard camera 326, and to store those imaging devices/cameras locally, such as in the volatile memory 315 and/or non-volatile memory 324. As discussed herein, the mobile computing entity 120 may be further configured to match the captured image data with relevant location and/or time information captured via the location determining aspects to provide contextual information/data, such as a time-stamp, date-stamp, location-stamp, and/or the like to the image data reflective of the time, date, and/or location at which the image data was captured via the camera 326. The contextual data may be stored as a portion of the image (such that a visual representation of the image data includes the contextual data) and/or may be stored as metadata associated with the image data that may be accessible to various computing entities.

The mobile computing entity 120 may include other input mechanisms, such as scanners (e.g., barcode scanners), microphones, accelerometers, RFID readers, and/or the like configured to capture and store various information types for the mobile computing entity 120. For example, a scanner may be used to capture package/item/shipment information/data from an item indicator disposed on a surface of a shipment or other item. In certain embodiments, the mobile computing entity 120 may be configured to associate any captured input information/data, for example, via the onboard processing element 308. For example, scan data captured via a scanner may be associated with image data captured via the camera 326 such that the scan data is provided as contextual data associated with the image data. Scan data may include a package scanned time stamp,

The mobile computing entity 120 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, information/data, applications, programs, program modules, scripts, source code, object code, byte code, compiled code, interpreted code, machine code, executable instructions, and/or the like to implement the functions of the mobile computing entity 120. As indicated, this may include a user application that is resident on the entity or accessible through a browser or other user interface for communicating with the volume forecast entities 100 and/or various other computing entities.

In another embodiment, the mobile computing entity 120 may include one or more components or functionality that are the same or similar to those of the volume forecast entities 100, as described in greater detail above. As will be recognized, these architectures and descriptions are provided for exemplary purposes only and are not limiting to the various embodiments.

### 5. Exemplary Package/Item/Shipment Information

As noted herein, various shipments/items may have an associated package/item/shipment profile, record (also referred to herein as a parcel profile), and/or similar words used herein interchangeably stored in a parcel detail database. The parcel profile may be utilized by the carrier to track the current location of the parcel and to store and retrieve information/data about the parcel. For example, the parcel profile may comprise electronic data corresponding to the associated parcel, and may identify various shipping instructions for the parcel, various characteristics of the parcel, and/or the like. The electronic data may be in a format readable by various computing entities, such as an volume forecast entity 100, a mobile computing entity 120, an autonomous vehicle control system, and/or the like. However, it should be understood that a computing entity configured for selectively retrieving electronic data within various parcel profiles may comprise a format conversion aspect configured to reformat requested data to be readable by a requesting computing entity.

In various embodiments, the parcel profile comprises identifying information/data corresponding to the package/item/shipment. The identifying information/data may comprise information/data identifying the unique parcel identifier associated with the parcel. Accordingly, upon providing the identifying information/data to the parcel detail database, the parcel detail database may query the stored parcel profiles to retrieve the parcel profile corresponding to the provided unique identifier.

Moreover, the parcel profiles may comprise shipping information/data for the parcel. For example, the shipping information/data may identify an origin location (e.g., an origin serviceable point), a destination location (e.g., a destination serviceable point), a service level (e.g., Next Day Air, Overnight, Express, Next Day Air Early AM, Next Day Air Saver, Jetline, Sprintline, Secureline, 2nd Day Air, Priority, 2nd Day Air Early AM, 3 Day Select, Ground, Standard, First Class, Media Mail, SurePost, Freight, and/or the like), whether a delivery confirmation signature is required, and/or the like. In certain embodiments, at least a portion of the shipping information/data may be utilized as identifying information/data to identify a parcel. For example, a destination location may be utilized to query the parcel detail database to retrieve data about the parcel.

In certain embodiments, the parcel profile comprises characteristic information/data identifying parcel characteristics. For example, the characteristic information/data may identify dimensions of the parcel (e.g., length, width, height), a weight of the parcel, contents of the parcel, and/or the like. In certain embodiments, the contents of the parcel may comprise a precise listing of the contents of the parcel (e.g., three widgets) and/or the contents may identify whether the parcel contains any hazardous materials (e.g., the contents may indicate whether the parcel contains one or more of the following: no hazardous materials, toxic materials, flammable materials, pressurized materials, controlled substances, firearms, and/or the like). In various embodiments, the information in the parcel profile includes volume forecast data or volume information units that are fed through a learning model, as described in more detail herein.

### IV. Exemplary System Operation

FIG. 4-6 illustrates flowcharts illustrating operations performed by an example system in accordance with some embodiments discussed herein. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory of an apparatus employing an embodiment of the present invention and executed by a processor of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the functions specified in the flowchart blocks. The computer program instructions may also be loaded onto a computer or other programmable apparatus to cause a series of operations to be performed on the computer or other programmable apparatus to produce a computer-implemented process such that the instructions executed on the computer or other programmable apparatus provide operations for implementing the functions specified in the flowchart blocks.

FIG. 4 illustrates a flow diagram of an example process 400 for generating a volume forecast, according to some embodiments. In some embodiments, the volume forecast entity 100 performs the process 400. In some embodiments, the process 400 illustrated in FIG. 4 is, for example, performed by an apparatus as described above. And in this regard, the apparatus may perform these operations using a volume forecasting engine operating through the use of one or more of processing element 305, non-volatile memory 310, and volatile memory 315. It will be understood that the volume forecasting engine comprises a set of hardware components or hardware components coupled with software components configured to autonomously generate a volume forecast. These components may, for instance, utilize the processing element 305 to execute operations, and may utilize non-volatile memory 310 to store computer code executed by the processing element 305, as well as to store relevant intermediate or ultimate results produced from execution of the volume forecasting engine. It should also be appreciated that, in some embodiments, the volume forecasting engine may include a separate processor, specially configured field programmable gate array (FPGA), or application specific interface circuit (ASIC) to perform its corresponding functions. In addition, computer program instructions and/or other type of code may be loaded onto a computer, processor or other programmable apparatus's circuitry to produce a machine, such that the computer, processor other programmable circuitry that execute the code on the machine create the means for implementing the various functions described in connection with the volume forecasting engine.

At block 401, one or more volume information units are accessed (e.g., by the volume forecasting engine) from one or more sources, such as a volume forecast data management tool. In some embodiments, the one or more volume information units comprise volume forecast data, and wherein the volume forecast data comprises one or more of a package received time or package information. In some embodiments, the volume forecast data comprises one or more of: a package received time, a manifest package time, package information such as tracking number, a package activity time stamp, package dimension including the height, length and width of the package, a package weight, a package manifested weight, a package manifest time stamp, a package service type, a package scanned time stamp, a package tracking number, a package sort type code, a package scanned code, a unit load device type code, account number associated with the package, and the like. In some embodiments, volume forecast data is received, over a computer network, from one or more vehicles (e.g., the vehicle 107) and/or one or more mobile computing entities (e.g., the mobile computing entity 120). Alternatively or additionally, in some embodiments, volume forecast data is received from other sources, such as one or more package manifests, shipper profiles, parcel profiles, etc. In some embodiments, volume forecast data is categorized to volume forecast data at different hierarchical levels and labeled with hierarchical level information. Hierarchical level information identifies a class of entities or particular set of data addressed by the volume forecast. In particular embodiments, the class of entities include entities having properties associating them with hierarchical levels of a particular account type, service type, building type, sort type, building identifier, package weight category, package dimension category, other categorizations of packages, shipper, or facilities in the shipping process. Example of other categorizations of packages, shipper or facilities are: facility location code, facility purpose (directly providing service to shippers such as a UPS store, or intermediary transit sites), building size, package categorized by different indicators defined in terms section, and the like.

In some embodiments, accessing the volume information units at block 401 is associated with one or more rules in order for the process 400 to automate. For example, a first rule may be, if one or more users (e.g., the first 50 users) or other entity provides one or more package manifests (e.g., a batch of 100 package manifests), provides shipping transaction data (e.g., data from one or more labels printed for a user at a shipping store), and/or any volume forecast data, the system automatically accesses volume information units at block 401, automatically extracts features at block 402, and automatically generates output at block 403 for the data provided by the user or other entity. In this way, particular embodiments improve existing technology by automating functionality that was previously performed via manual computing system entry, such a user generating its own prediction value into a computer system based on personal observation or manually inputting spreadsheet values for prediction. In an example illustration of particular embodiments, a rule may be that the process 400 will automatically occur only after X time period (e.g., 20 days) for all data received (e.g., 100 package manifests). In this way automation can be batched or chunked to reduce I/O cycles.

In an example illustration of how volume forecast data is categorized to one or more hierarchical levels, a generation of a mapping can occur. For example, a system (e.g., the volume forecast entity 100) can include a data structure, such as a hash table of predefined categories (e.g., a package weight category). For each set of information obtained in the volume forecast data (e.g., a weight value), the set of information is mapped to the predefined category. Mapping in various embodiments is or includes utilizing word matching algorithms, such as TF-IDF. For example, a package manifest includes the word “weight,” and thus the value next to weight is extracted from the package manifest, weighted with a high score, and assigned to a “weight” category hierarchical level based on the high score. Alternatively or additionally, in various embodiments mapping is or includes using other models, such as a first learning model (e.g., random forests, WORD2VEC, etc.).

At block 402, the volume forecasting engine extracts one or more features from the one or more volume information units, wherein the one or more features are representative of one or more of a package received time or package information in various embodiments. In some embodiments, the features are generated by directly copying volume information units. Alternatively or in addition, the features can be generated from other techniques, such as mapping each individual set of information to a classification. For example, if a volume information unit comprises “manifest time: 9:00 am; received time: 10:04 am; package weight: 30 lb”, the features generated can be based on separating each of the constituent elements present in the volume information unit, and in this case, the first feature may be “manifest time: morning”, the second feature may be “received time: morning”, and the third feature may be “package weight: heavy”. In some embodiments, one feature may be generated based on multiple volume information units. For example, the package received times for multiple occasions can be used to generate one feature. A volume forecasting engine may use volume information units that represent packages received in the past two months at a building coded “5cdx” and may generate a feature called “total amount of packages during the past two months at building coded 5cdx”. Features can be generated for each hierarchical level. For example, features are generated for one or more hierarchical levels of: an account type, service type, building type, sort type, building identifier, package weight category, package dimension category, other categorizations of packages, shipper, set of facilities in the shipping process, and/or the like. The features may be labeled with hierarchical level information. In various embodiments, extracting features at block 402 is or includes further classifying or categorizing information within each hierarchical level. In this way, each hierarchical level is further filtered or refined from a single category to one or more sub-categories of the single category. For example, a hierarchical category may be a “package weight” category. Accordingly, when features are extracted from data (e.g., volume information units) assigned to the package weight category, the values (e.g., 0.8 Lbs. envelope, 3 Lbs. package, etc.) of the features may be assigned to one or more additional sub-categories, such as “heavy,” or “light.” (e.g., 0.8=light; 3 Lbs.=heavy).

In some embodiments, extracting features at block 402 includes generating a mapping of some or each of the received volume forecast data to one or more classes. The generating of the mapping may include utilizing one or more data structures (e.g., a hash table) and/or learning models (e.g., a word embedding vector model). For example, in some embodiments, some or each of the volume forecast data is run through a word embedding vector model (e.g., WORD2VEC). A word embedding vector model includes vectors that represent words in vector 2-D or 3-D space, where the distance (e.g., cosine distance) between two vector sets or words is directly proportional to the contextual similarity (e.g., semantic similarity) between the two words. Accordingly, the closer any two words are, the more contextually similar they are to each other. Alternatively, the further away they are from each other, the less contextually similar they are to each other. Therefore, in response to running one or more of the volume forecast data through the word embedding vector model, the closest word in vector space may be its category or hierarchical level. For example, the first value of a package weight of 2.3 pounds may be run through a word embedding vector model. The closest first identifier in vector space may be 2-4 pounds (as opposed to 0-3 pounds, or 5-10 pounds). Accordingly, the first value is mapped to the first identifier only, which is indicative of the first value of 2.3 pounds falling in the range of the first identifier of 2-4 pounds.

At block 403, the volume forecasting engine generates an output comprising a volume forecast for a particular hierarchical level (and/or extracted feature) using a volume forecast learning model and the one or more features. The volume forecast learning model can utilize various different sub-models (e.g., models used on the output forecasts/predictions of other models), for example, time-series learning models such as autoregressive integrated moving average models and/or exponential smoothing based models, and classification models such as random forest based models and gradient smoothing based models. In an example illustration, output results from a machine learning model can be run through an Exponential smoothing forecast model in order to smooth out or assign exponentially decreasing weights as a time sequence gets older or progresses. Accordingly, in various embodiments, recent observations (e.g., parcel volume within the last X quantity of days (e.g., 5 days)) are given relatively more weight in forecasting than older observations (e.g., observations greater than Y quantity of days (e.g., 6 days or older). Thus a first machine learning model may indicate that for a particular hierarchical level, there will likely be X quantity of shipments that will be received. However, this prediction may be based on 80% of actual values that are relatively old, such as over 3 years old. Accordingly, the X quantity of shipments may be run through another model, such as an exponential smoothing forecast model to reduce prediction quantities for older data and increase prediction quantities for newer data.

In some embodiments, the learning models can be implemented using programming languages such as R, Java, C, Scala, Python, Weka or C++, although other languages may be used in addition or in the alternative. Similarly, the learning models can be implemented using existing modules and a framework for machine learning such as Apache Spark, Apache Hadoop, Apache Storm, or Apache Flink, although other frameworks may be used in addition or in the alternative. Additionally or alternatively, the shipper behavior learning model is capable of running on a cloud architecture, for example, on cloud architectures based on existing frameworks such as a Hadoop Distributed File System (HDFS) of a Hadoop cluster. In some embodiments, the cloud architectures are memory based architectures where RAM can be used as long term storage to store data for faster performance and better scalability compared to other types of long term storage, such as a hard disk.

In embodiments utilizing time-series learning models, the time-series learning models may apply exponential smoothing to the features extracted. This may be done by assigning weights (e.g., a particular a (alpha) constant) to features that are representative of time-series data. For example, features indicating volume data for a particular hierarchical level are extracted and the features extracted are associated with different time frames. For example, a package manifest may indicate that a 5.3 pound package (e.g., extracted feature of “heavy”) was scheduled to be received by a shipping center at 4.30 p.m. on Monday. Accordingly, “weight” and “heavy” are associated with 4:30 p.m. and/or a particular date or set of times (e.g., “late afternoon,” or “July 5”). The features associated with the more recent time-frames will be assigned greater weight than the features associated with the less recent time frames in various embodiments. The features may be indicative of volume information. For example, features can be indicative “Volume of large size packages for building coded 3edb yesterday”, “Volume of large size packages for building coded 3edb between two days ago and yesterday”, etc. For an example of these features, the hierarchical level information may be the building coded “3edb” and large size packages. The features indicative of “Volume of large size packages for building coded 3edb yesterday” may be assigned a higher weight compared to “Volume of large size packages for building coded 3edb between two days ago and yesterday”.

In some embodiments, after assigning weights to extracted features, a time-series learning model may calculate a weighted average of the extracted features. Then the time-series learning model may calculate a trend based on the weighted average. Further, the time-series model may calculate weighted moving averages, centered moving averages, and/or two sided moving averages. In one example embodiment, the process of assigning weights and generating trends are illustrated by the following equations:

ŷ_{t+h|t}=lₜ+hbₜ Forecast generating equation:

lₜ=αyₜ+(1−α)(lₜ₋₁+bₜ₋₁) Level equation:

bₜ=β(lₜ−lₜ₋₁)+(1−β)bₜ₋₁, Trend equation:

where lₜ denotes an estimated level of yₜ which denotes the volume information of calculated based on the feature extracted at time frame/sequence t (for example, if feature extracted is: “Volume of large size packages for building coded 3edb yesterday=500”, y_{yesterday} would be 500 when generating forecasts for large size packages at building 3edb, the hierarchical levels can be adjusted accordingly), bₜ illustrates the trend (slope) calculated based on the slope calculated based on multiple features that are representative of time-series data; and ŷ_{t+h|t} denotes a forecast of volume for h further time frames. For example, the time frame can be per one day and to generate volume forecasts in the next five days, one would set h=to 5. α is a pre-defined smoothing factor for the level equation, and β is a pre-defined smoothing factor for the trend equation. By adjusting the smoothing factors, one can fine tune the equations. The basis for fine tuning may be previous volume information and features extracted. For example, one can run the model using features generated and generate a volume forecast for a time-period about which one has actual knowledge of package volume. Then, comparing the volume forecast with the actual volume information, provides insight into an appropriate manner by which to adjust the parameters to harmonize the predicted volume with the actual volume. Subsequently, one can reiterate the process of fine-tuning the parameters. The process of fine tuning parameters can be done manually or by using another machine learning model, such as a classification model. An error correction model may be used in association with the previous equations, provided by these equations:

lₜ=lₜ₋₁+bₜ₋₁+αeₜ

bₜ=bₜ₋₁+αβeₜ

eₜ=yₜ−lₜ₋₁−bₜ₋₁,

in which to initiate the method, one can set l₀=y₁ and b₀=y₂−y₁.

In one example embodiment, the process of assigning weights and generating trends are illustrated by the following equations:

$$Forecast generating equation \text{:} {\hat{y}}_{t + h \vert t} = {l}_{t} {hb}_{t}^{h}$$

$$Level equation \text{:} {l}_{t} = α {y}_{t} + ( 1 - α ) ( {l}_{t - 1} {b}_{t - 1} )$$

$$Trend equation \text{:} {b}_{t} = β ( \frac{{l}_{t}}{{l}_{t - 1}} ) + ( 1 - β ) {b}_{t - 1} .$$

Again, lₜ denotes an estimated level of yₜ which denotes the volume information of calculated based on the feature extracted at time frame t (for example, if feature extracted is: “Volume of large size packages for building coded 3edb yesterday=500”, y_{yesterday} would be 500 when generating forecasts for large size packages, the hierarchical levels can be adjusted accordingly), bₜ illustrates the trend (slope) calculated based on the slope calculated based on multiple features that are representative of time-series data. ŷ_{t+h|t} denotes a forecast of volume for h further time frames. For example, the time frame can be per one day and to generate volume forecasts in the next five days, one would set h=to 5. α is a pre-defined smoothing factor for the level equation and β is a pre-defined smoothing factor for the trend equation. By adjusting the smoothing factors, one can fine tune the equations. The basis for fine tuning may be previous volume information and features extracted. For example, one can run the model using features generated and generate a volume forecast for a time-period about which one has actual knowledge of package volume. Then, comparing the volume forecast with the actual volume information, provides insight into an appropriate manner by which to adjust the parameters to harmonize the predicted volume with the actual volume. Subsequently, one can reiterate the process of fine-tuning the parameters. The process of fine tuning parameters can be done manually or by using another machine learning model, such as a classification model. An error correction model may be used in association with the previous equations, provided by these equations:

lₜ=lₜ₋₁bₜ₋₁+αeₜ

bₜ=bₜ₋₁+αβeₜ/lₜ₋₁

eₜ=yₜ−lₜ₋₁bₜ₋₁,

in which to initiate the method, one can set l₀=y₁ and b₀=y₂/y₁

Alternatively or additionally, other exponential smoothing models can be used in other embodiments. For example, models may be selected that are based on a damped trend, Holt-Winters seasonal method, autoregressive integrated moving average models, long short term memory recurrent neural networks, and the like. By switching the time-series learning model used, one can fine tune the volume forecasting models. As with the models described previously, the basis for fine tuning may be previous volume information and features extracted. For example, one can run the model using features generated and generate a volume forecast for a time-period about which one has actual knowledge of package volume. Then, comparing the volume forecast with the actual volume information, provides insight into an appropriate manner by which to adjust the parameters to harmonize the predicted volume with the actual volume. Subsequently, one can reiterate the process of fine-tuning the parameters. The process of fine tuning parameters can be done manually or by using another machine learning model, such as a classification model. A classification model will evaluate results outputted by different time-series learning models by comparing volume forecasts generated and actual volume data extracted from features extracted from volume information units.

A classification model can be utilized to determine which time-series learning model to use. For example, a random-forest based classification model can be utilized and volume to evaluate volume forecasts generated (note: not necessarily the output for the volume forecast learning model) for a time-period in which volume information is already known, and evaluate the volume forecast generated using the classification model. Based on the values or time period (e.g., recent or old), different time-series learning models can be used, such as selecting an autoregressive integrated moving average models instead of exponential smoothing based models. Alternatively or additionally, one can use a classification model in conjunction with a time-series learning model to fine tune the parameters in a time-series learning model. The classification model may include a random forest based learning model, a gradient boosting based learning model, a neural network based learning model, naïve Bayes learning model and/or the like.

Additionally or alternatively, additional predictors, such as features indicating geographical events, weather reports, political events, traffic data, and the like are fed into the classification models and used to generate volume forecasts in conjunction with a time-series learning model. For example, one can use geographical events, weather reports, political events, and/or traffic data to construct label features representative of time series volume information and fine tune parameters in time-series learning model based on geographical data, weather reports, political events, traffic data, etc. For example, a data source may reveal that there is a large community event in town Z. Accordingly, this data is used for a hierarchical level (e.g., shipping facility in town Z) that the quantity of shipments that will be received will be reduced the day of the large community event. Additionally or alternatively, for a selected period of time to forecast, one can selectively feed features representative of time series volumes that are being labeled as similar to the selected period of time based on geographical data, weather reports, political events, traffic data, etc. For example, if one wants to generate a volume forecast during Thanksgiving season at a building coded “exy0”, one can use features representative of volume information during the Thanksgiving season at the building coded “exy0” and other buildings that are labeled as similar to the building coded “exy0” based on geographical data, weather reports, political events, traffic data, etc.

In some embodiments, the time-series learning model comprises various different models, such as dynamic Bayesian forecasting models, autoregressive integrated moving average models, exponentially weighted moving average models, and/or the like. For example, one can use an autoregressive integrated moving average model to generate volume forecasts. Autoregressive integrated moving average models (otherwise referred to as the “Box-Jenkins method”, shortened as “ARIMA” hereinafter) operate using the following several steps. The features fed into the ARIMA model are features generated from volume information arranged as time-series data. The features may represent volume information at a specific hierarchical level. For example, the features may take the form of “Volume of large packages at building coded 3xyz on July 5^{th}”. The ARIMA model then checks whether the features are stationary, i.e., whether the statistical properties such as mean, variance, autocorrelation structure are all constant over time. For example, if the time series features shows seasonality (i.e., periodic fluctuations), then it's not stationary. In the context of a volume forecast, seasonality often occurs if the period to be forecasted includes holidays, weekends, and the like since there would be large fluctuations at these time periods. In some embodiments, intervention techniques are applied at these particular time periods, such as, for example, by providing a value for the time periods where large fluctuations are identified to replace the original value and smoothen the time series data.

In some embodiments, the output provided by the volume forecasting model comprises statistical errors, for example, errors calculated by the error rate provided above. Additionally or alternatively, statistical errors can be calculated by using a mean absolute percent error, a weighted mean absolute percent error, a root mean squared error, a mean absolute scaled error, a bias, and/or the like. In some embodiments, a weighted mean absolute percent error is provided in the output because the weighted mean absolute percent error places more significance on data of larger relevance. Statistical errors can be provided at each hierarchical level (if volume forecasts are generated for different hierarchical levels) by labeling respective time series data with hierarchical level information and calculating statistical errors based on the time series data labeled with the respective hierarchical level information.

In some embodiments, the output provided by the volume forecasting model comprises hierarchical level information details which comprises one or more of: an account type, a service type, a building type, a sort type, a building identifier, a package weight category, a package dimension category, other categorizations of packages, a shipper, sets of facilities in the shipping process, time stamp data indicating when the forecast is generated, building types associated with the forecast, and package received times at different defined time frames such as days of the week, months of the year and the like, identifiers of buildings, classifications of or average package weight, indicators indicating correlation between any of the volume forecast data in the form of probability scores, predicted averages and/or classifications, and/or the like.

FIG. 5 illustrates a flow diagram of an example process 500 for updating a volume forecasting engine, according to some embodiments. The operations illustrated in FIG. 5 may, for example, be performed by an apparatus or volume forecast entity 100 as described above. In this regard, the volume forecast entity 100 may perform these operations through the use of one or more of processing element 305, non-volatile memory 310, and volatile memory 315.

At block 501, additional volume forecast data is received (e.g., by the volume forecasting engine) after a particular time period (e.g., a time period after the process 400 is performed). In some embodiments, the particular time period reflects the time period when additional volume information for the period of time being forecasted are received in FIG. 4. For example, if the features previously used to generate volume forecasts for the first five days (e.g., days 1-5) for the building coded “3xyz”, the particular time period may be configured as the time period where additional volume forecast data is received for the next five days (e.g., days 6-10) for the building coded “3xyz”. At block 502, the volume forecasting engine extracts one or more features from the additional volume forecast data. At block 503, the volume forecasting engine updates itself based on the features extracted from additional volume forecast data. In some embodiments, the volume forecasting engine updates itself by changing the decision tree parameters associated with the volume forecast learning model. In some embodiments predictions are changed or modified at block 503 and/or additional predications are generated. For example, a prediction can be made via the process 400 that a first quantity of parcels will be received for a first time sequence (e.g., first five days). In response to blocks 501 and 502 to process additional data, the prediction of the first quantity is changed to a second quantity for the same first time sequence based on processing the additional data. In another example, the process 400 may predict volume for a first time sequence (e.g., day 1-4) and the process 500 may include predicting volume for a second time sequence (e.g., day 5-10) after the first time sequence. In this way, additional predictions are generated via the process 500.

FIG. 6 illustrates another flow diagram of an example process 600 for modifying a volume forecast learning model, according to some embodiments. In some embodiments, the process 600 is performed by the volume forecast entity 100. The operations illustrated in FIG. 6 may, for example, be performed by an apparatus as described above. And in this regard, the apparatus may perform these operations through the use of one or more of processing element 305, non-volatile memory 310, and volatile memory 315.

At block 601, the volume forecasting engine receives additional volume forecast data after a particular time period (e.g., after the process 400). At block 602, the volume forecasting engine extracts one or more features from the additional volume forecast data (e.g., current data, such as current package manifest information). At block 603, the volume forecasting engine accesses historical data (e.g., historical package manifest information) to generate a historical data set for one or more historical volume forecast. In some embodiments, “historical data” may be or include any data that was received and/or analyzed prior to the receiving of the data at block 601. At block 604, the volume forecasting engine extracts one or more features from the historical data set. As illustrated in FIG. 6, the operations performed at blocks 601 and 602 can be performed before, after, or concurrently with the operations performed at blocks 603 and 604. At block 605, the features extracted from the additional volume forecast data is compared (e.g., by the volume forecasting engine) with the features extracted from the historical data set. At block 606, the volume forecasting engine modifies the volume forecast learning model stored in the volume forecasting engine based on the difference between the one or more features extracted from the additional volume forecast data and the one or more features extracted from the historical data set. In some embodiments, the volume forecasting engine modifies the volume forecast learning model by reading inputs from an operator or a learning model analyzing the difference between the one or more features extracted from the additional volume forecast data and the one or more features extracted from the historical data set.

In an example illustration of the process 600, the volume forecast learning model may indicate that for a particular day or time sequence of a particular month, there are have been an average of 50 “heavy” shipments (the historical data at 603) received. However, the additional volume forecast data (block 601) may indicate that for the same particular day or time sequence of the same particular month in a different year, it is projected that there will be 100 “heavy” shipments received. 100 is compared with 50 (block 605) and modifications are made (block 606). For example using the illustration above, instead of projecting there will be around 50 shipments received based only on the historical data, it is projected that there will be a higher quantity this year, which takes into account both the historical data and the current additional volume forecast data. For example, the modification at block 606 may include averaging the historical projections (e.g., 50) with the additional volume forecast data (e.g., 100) to arrive at a new projection for forecast volume.

FIG. 7 is an example block diagram of an example system 700 of an example volume forecast learning model training environment. They system 700 is used to train the volume forecast learning model 710 that is relied upon by the volume forecast entity 100 to update the volume forecast learning model 710 in some example embodiments. The depicted system 700 comprises a training engine 702, a volume forecast learning model 710, and a volume forecast data management tool 715. “Training” as described herein in various embodiments includes a user manually mapping each set of data to a target attribute or correct classification (e.g., small packages) and the model locates or identifies patterns within the target attribute in preparation for testing (e.g., running a data set through a model without a user mapping to a target attribute; rather the system automatically maps without user interaction). For example, training data may include 10 weight values, which may each be over 3 pounds. A user may input information on a computing device and associate each of the weight values to a “heavy” category. The system may identify the actual values as being associated with a “heavy” category. In this way at testing time, the system may automatically map any current values to the same or similar values that have already been mapped to the heavy category via a user device.

In some examples, the volume forecast data management tool 715 comprises a variety of volume forecast data. In some examples, the historical data may be obtained and/or stored after volume forecast entity 100 receives package received time data. For example, the volume forecast data management tool 715 may comprise historical package received time data 720, shipper profile 722, package manifest 724, package information 726, and/or other data 728. In some embodiments, package received time data 720 includes an actual time that one or more packages were received, such as at a shipping store (as opposed to a plan receive time indicated in a package manifest). In various embodiments, the shipper profile 722 includes one or more of: shipper name, shipper address, destination address, delivery service type, etc. In various embodiments, the package information 726 includes dimensions of the package (e.g. length, width, and/or height), the weight of the package, name of item encompassed by the package, etc.

In some embodiments, the volume forecast data comprises a package received time, a manifest package time, a package information such as tracking number, a package activity time stamp, a package dimension including the height, length and width of the package, a package weight, a package manifested weight, a package manifest time stamp, a package service type, a package scanned time stamp, a package tracking number, a package sort type code, a package scanned code, a unit load device type code, an account number associated with the package, and/or the like. In some embodiments, volume forecast data may be received from vehicles or mobile computing entities.

In some examples, the training engine 702 comprises a normalization module 706 and a feature extraction module 704. The normalization module 706, in some examples, may be configured to normalize (e.g., via Z-score methods) the historical data so as to enable different data sets to be compared. Normalization is the process of changing one or more values in a data set (e.g., the volume forecast data management tool 715) to a common scale while maintaining the general distribution and ratios in the data set. In this way, although values are changed, differences between actual values in the data set are not distorted such that information is not lost. For example, values from the volume forecast data management tool 715 may range from 0 to 100,000. The extreme difference in this scale may cause problems when combining these values into the same features for modeling. In an example illustration, this range can be changed to a scale of 0-1 or represent the values as percentile ranks, as opposed to absolute values.

In some examples, the feature extraction module 704 is configured to parse the volume forecast data into volume information units relevant to modeling of the data, and non-volume information units that are not utilized by the volume forecast learning model 710, and then to normalize each distinct volume information units using different metrics. For example, the volume information units can be labeled or categorized based on package received time, package manifest time, package dimension, package weight, frequency of shipping from a particular shipper associated with the package, building type, account type, sort type, other package information from scanners, other package information from package manifest, other package information from mobile computing entities, and the like. Moreover, volume information units can be labeled with geographical data, traffic data, holiday information, weather reports, political events, and/or the like. For the purpose of categorizing the volume information units, the information used to label or categorize volume information units may be processed (such as labeled, categorized and parsed) first.

Alternatively or additionally, the normalization module 706 may be usable with respect to processing volume forecast data in the volume forecast data management tool 715, such as to normalize the volume forecast data before the volume forecast data is labeled or otherwise characterized by feature extraction module 704. For example, repetitive volume forecast data corresponding to the same instance received from multiple sources may be de-duplicated.

Finally, the volume forecast learning model 710 may be trained to extract one or more features from the historical data using pattern recognition, based on unsupervised learning, supervised learning, semi-supervised learning, reinforcement learning, association rules learning, Bayesian learning, solving for probabilistic graphical models, k-means based clustering, exponential smoothing, random forest model based learning, or gradient boosting model based learning, among other computational intelligence algorithms that may use an interactive process to extract features from volume forecast data. In some embodiments, the volume forecast learning model is a time-series learning model.

In an example illustration of training according to the system 700, data may be obtained from the various data sources by the volume forecast data management tool 715 (various historical documents, such as package manifests and shipping transaction histories over a particular time frame). In order to provide more meaning to the data, the feature extraction module 704 can extract one or more features from the data in the volume forecast data management tool 715. For example, a user can create a data structure of various features, such as “morning,” “afternoon,” “evening,” “light parcel,” “heavy parcel,” “January,” and associate specific data within the volume forecast data management tool 715 with the features. For example, training data indicating that a parcel was received at “3:00 p.m.” is associated with the “afternoon” feature. In like manner, training data indicates that a parcel was “4 LBS” was associated with the “heavy parcel” feature. In some embodiments, after each feature is extracted, volume forecast numbers are calculated for each feature. For example, for “heavy” parcels in “January” in the last year, there were 87 parcels received by a shipping facility.

Each set of data within each feature can then be normalized via the normalization module 706 in some embodiments. Each value (e.g., 87 shipments) of each feature represents data points in a learning model where patterns and associations are made to make a suitable projection for volume forecasts. For example, after the data points of the features are all associated to features, the volume forecast learning model 710 can then identify patterns and associations to learn information. For example, the volume forecast learning model 710 may identify the pattern that for all “heavy” shipments that were shipped between 12:00 a.m. and 11:59 a.m. (i.e., “morning” feature) during a first time period (e.g., December 1-December 25) there were an average of 200 shipments received by a shipping facility. In this way, when the volume forecast learning model 710 evaluates future test data or data for current shipments, it does not need explicit user programming or input to predict what the volume for a particular time will be. For example, using the illustration above, December 1 may be five days away. The volume forecast learning model 710 may predict that during the time sequence of December 1-25, for “heavy” and “morning” shipments, there will likely be around 200 shipments received based on the training data associations made via the training engine 702.

FIG. 8 is a block diagram of an example system 800 of a volume forecast learning model service environment. In some example embodiments, the system 800 comprises volume forecast data 810, a volume forecasting engine 830, output 840, the volume forecast data management tool 715 and/or the volume forecast learning model 710. The volume forecast data management tool 715, volume forecasting engine 830, and output 840 may take the form of, for example, a code module, a component, circuitry and/or the like. The components of the volume forecast learning model service environment 800 are configured to provide various logic (e.g. code, instructions, functions, routines and/or the like) and/or services related to the volume forecast learning model service environment.

In some examples, the volume forecast data 810 comprises historical data processed at some time prior to a current time, such as package received time data, shipper profile, package manifest, package information, and/or other data. In some examples, the volume forecast data management tool 715 may be configured to normalize the raw input data, such that the data can be analyzed by the volume forecasting engine 830. In some examples, the volume forecast data management tool 715 is configured to parse the input data interaction to generate one or more volume information units. Alternatively or additionally, the volume forecasting engine 830 may be configured to extract one or more features from the one or more volume information units. In some embodiments, the features are generated by directly copying volume information units. Alternatively or in addition, the features can be generated using other techniques. For example, if the volume information unit comprises “manifest time: 9:00 am; received time: 10:04 am; package weight: 30 lb”, the features generated can be based on categorization of each of the elements present in the volume information units in the form of “manifest time: morning; received time: morning; package weight: heavy”. In some embodiments, one feature may be generated based on multiple volume information units. In this regard, the package received time for multiple occasions can be used to generate one feature. For example, a volume forecasting engine may use volume information units that represents a package manifest time and package received time in the past two days in the building coded “3xyz” and generate a feature called “total volume for past two days”.

In some examples, the volume forecast data management tool 715 and volume forecasting engine 830 are configured to receive a volume forecast learning model, wherein the volume forecast learning model was derived using a historical volume forecast data set. Alternatively or additionally, the volume forecasting engine 830 may be configured to generate generating an output 840 based on the volume forecast learning model and the one or more features. In some embodiments, the output 840 comprises a volume forecast for a particular hierarchical level. Alternatively or additionally, the output 840 comprises the hierarchical level information comprising one or more of an account type, a service type, a building type, a sort type, a building identifier, a package weight category, a package dimension category, or other categorizations of packages, shipper, buildings or sets of facilities in the shipping process.

Without volume forecast generating capabilities, a carrier would not be able to efficiently allocate resources for package delivery. Such resources may comprise human resources and transportation resources such as vehicles. Accordingly, there is a latent need for tools that improve the accuracy of volume forecast.

By providing volume forecasts using volume forecast entity 100 to a computing entity configured to determine resource allocations, resources can be better allocated with regard to each transportation facility. For example, if a volume forecast indicates that the transportation facility at 123 Fictional Street will have a sudden increase in in-bound package volume in the next three days, more resources can be allocated to deal with the sudden increase. For example, a supervisor can temporarily hire additional staff to help meet the needs of the sudden increase. Moreover, by generating volume forecasts at different hierarchical levels, the resources allocated can be specifically tailored to the hierarchical levels based on the predicted volume for each hierarchical level, such as various different types of packages, overweight packages, packages with unusual dimensions, packages with hazard materials, urgent packages, specific time-frames, specific building, and the like. By autonomously generating volume forecasts using volume forecast entity 100, a computing entity configured to determine resource allocations can reduce issues caused by human error and mitigate potential resource misallocation.

FIG. 9A is a schematic diagram of an example exponential smoothing forecast model table 900, according to some embodiments. Although the table 900 includes specific values, calculations (e.g., WMAP), and time sequences (day 1-5), it is understood that this is representatively only and that any set of values, calculations, and/or time sequences can exist. For example, instead of or in addition to making volume forecasts for a particular set of “days,” there may be forecasts for a particular sequence of months, years, weeks, and/or any other time period sequence. In another example, instead of or in addition to calculating WMAPE (weighted mean absolute percent error), other model accuracy validation methods can be used, such as root mean square error (RMSE), mean absolute percent error (MAPE), mean square error (MSE), and/or any other suitable error calculation mechanism. In various embodiments, the table 900 (or similar table with the same calculations) is included in or used with one or more learning models, as described above with respect to block 403 of FIG. 4, block 503 of FIG. 5, block 606 of FIG. 6, the volume forecast learning model 710 of FIG. 7, and/or the volume forecast learning model 710 of FIG. 8. In some embodiments, the table 900 represents a data structure stored in memory, such as a hash table. In some embodiments, the table 900 alternatively or additionally includes an additional column of extracted features (e.g., the features extracted at block 502 of FIG. 5). In some embodiments, the table 900 is configured to be stored in memory and be displayed (e.g., to the mobile computing entity 120) in response to or while generating output of a volume forecast (e.g., block 403 of FIG. 4, block 503 of FIG. 5, and/or block 606 of FIG. 6).

The table 900 illustrates what the volume forecast or prediction will be for days 1 through 5 for one or more hierarchical levels Y. The one or more hierarchical levels Y can be any suitable hierarchical level or set of hierarchical levels as described herein, such as “account,” (1 hierarchical level) “account+service type,” (2 hierarchical levels) and “service type+sort” (2 hierarchical levels).

The particular values are populated within the table 900 based on exponential smoothing forecast algorithms. In various embodiments, generating a forecast or prediction for a particular day is generated through the following expression: Fₜ+1=αAₜ (1−α)Fₜ, where Fₜ+1 is a particular forecast/prediction of volume for a particular time period (day) or forecast/prediction for the current time period, where α (alpha) is a value between 0 and 1 (i.e., the smoothing constant), where Aₜ is the last actual volume value (e.g., actual quantity of received parcels) of the immediately preceding time period, and where Fₜ is the last forecast value (e.g., predicted quantity of parcels that a facility will receive) of the immediately preceding time period. For purposes of the specific values within the table 900, alpha a is assumed to be 0.2.

In an example illustration, at day three it may be currently unknown how many “small” parcels (first hierarchical level) will be received at sorting facility X (second hierarchical level). However, the learning model may project that there will be 34.2 small parcels that will be received at sorting facility X on day 3, as illustrated in the table 900. Accordingly, using the expression above, the new forecast or forecast at day three (Fₜ+1)=(0.2)(43)+(0.8)(32), which equals 34.2. That is, alpha 0.2 is multiplied by the last actual value Aₜ of day 2, which is 43. The result is a value of 8.6. Then 0.8 (the value of 1−α) is multiplied by 32, which is the last forecasted value Fₜ of day 2 to arrive at a value of 25.6. Then 8.6 is added to 25.6 to arrive at the final result of 34.2. Accordingly, even though the current actual volume value Aₜ of 56 may not be known at the time, it can be projected that there will be 34.2 small parcels received at sorting facility X on day 3. Then at a later time, the actual value for day 3 may be received, which is 56, which may be used to make future forecasts (day 4 and day 5). Day 5 illustrates a time period where the actual volume Aₜ is currently unknown, but the forecasted value Fₜ is still projected to be 41.65 based on using the expression above.

The “Error,” “Error²,” and “WMAP” columns of the table 900 are utilized to validate accuracy of the exponential smoothing forecast model. The values of the “Error” column are calculated by subtracting the forecasted values from the actual values for each time period (Aₜ−Fₜ). For example, for day 2, Aₜ value of 43 is used to subtract the Fₜ day 2 value of 32 to arrive at an “Error” value of 11. The “Error²” values are calculated by squaring each of the corresponding Error values for the same time period. For example, for day 2, the error value of 11 is squared to arrive at a value of 121. The “Error²” column can be used to generate other analyses, such as MSE, which is calculated by adding up each squared error of the table 900 and dividing this value by the total number of time periods (5 days). The “WMAPE” (weighted mean absolute percent error) is calculated via the following expression:

$$\frac{\sum \frac{\vert A - F \vert}{A} \times 100 \times A}{\sum A}$$

where A represents Aₜ or the current volume value for a particular day and F represents Fₜ or the currently forecasted volume value for the same particular day. For example, for day 2, the absolute value of 43 (the actual volume value)−32 (the forecasted volume value) is divided by 43 to arrive at 0.256. This value is then multiplied by 100 and 43 to arrive at the value of 1,100.0, which is then divided by 43 to arrive at the WMAPE value of 25.6 for day 2. WMAPE is utilized to focus on or weight errors that have a relatively larger impact or little to no impact at all. Standard MAPE calculations treat all errors equally, while WMAPE calculations place greater significance on errors associated with larger items by weighting these errors more.

FIG. 9B is a schematic diagram of an example time series graph 903 associated with the table 900 of FIG. 9A. The graph 903 represents actual and forecasted volume predictions for different alpha values and actual values. In some embodiments, the “time” axis (X-axis) is or includes days 1-5 as indicated in the table 900. For example, the “time” axis in the graph 903 can represent a larger time sequence, such as days 1-90, where days 1-5 (as indicated in FIG. 9A) is only a portion of the overall time sequence. The “volume” axis (Y-axis) represents the raw number or quantity (and projected quantities) of shipments or parcels received or shipped. The time series instance 905 represents the actual volume quantity received over a first time at a particular trend or slope. The time series instance 907 represents the projected volume quantity that will be received over the same first time at a first alpha level (e.g., 0.7) at a particular trend. The time series instance 909 represents the projected volume quantity that will be received over the same first time at a second alpha level (e.g., 0.2) at a particular trend. As illustrated in the graph 903, both the actual received volume and the volume projections become considerably larger as the time progresses. In some embodiments, the graph 903 is configured to be stored in memory and be displayed (e.g., to the mobile computing entity 120) in response to generating output of a volume forecast (e.g., block 403 of FIG. 4, block 503 of FIG. 5, and/or block 606 of FIG. 6).

In some embodiments, the methods, apparatus, and computer program products described herein comprise or utilize a volume forecasting engine configured to: access one or more volume information units from a volume forecast data management tool, wherein the one or more volume information units comprise volume forecast data, and wherein the volume forecast data comprises one or more of a package received time and package information; extract one or more features from the one or more volume information units, wherein the one or more features are representative of one or more of the package received time or the package information; and generate, using a volume forecast learning model and the one or more features, an output comprising a volume forecast for a particular hierarchical level.

Optionally, in some embodiments of the present disclosure, the output further comprises hierarchical level information.

Optionally, in some embodiments of the present disclosure, the output further comprises an indication of one or more statistical errors associated with the volume forecast.

Optionally, in some embodiments of the present disclosure, the volume forecasting engine is further configured to: generating, using the volume forecast learning model and the one or more features, one or more additional outputs comprising one or more corresponding additional volume forecasts for one or more corresponding additional hierarchical levels, wherein each of the one or more statistical errors comprises a statistical error for a corresponding one of the generated volume forecasts.

Optionally, in some embodiments of the present disclosure, the hierarchical level information identifies a class of entities addressed by the volume forecast, the class of entities comprising entities having properties associating them with a particular account type, service type, building type, sort type, building identifier, package weight category, package dimension category, other package categorization, shipper, or set of facilities in a shipping process.

Optionally, in some embodiments of the present disclosure, the volume forecast learning model comprises a time-series learning model.

Optionally, in some embodiments of the present disclosure, the time-series learning model comprises an autoregressive integrated moving average model or uses exponential smoothing.

Optionally, in some embodiments of the present disclosure, the volume forecast learning model comprises one or more of a neural network, a random forest based learning model, a gradient boosting based learning model or multiple adaptive regression splines.

Optionally, in some embodiments of the present disclosure, generating the volume forecast for the particular hierarchical level includes calculating, using the volume forecast learning model is configured to calculating one or more of: a mean absolute percentage error, a weighted mean absolute percentage error, a mean square deviation or a root mean square deviation.

Optionally, in some embodiments of the present disclosure, the volume forecasting engine is further configured to: receiving additional volume forecast data after a particular time period; extracting one or more features from the additional volume forecast data; and updating the volume forecasting engine based on the features extracted from the additional volume forecast data.

Optionally, in some embodiments of the present disclosure, the system or method, further comprises a training engine configured to: receive additional volume forecast data after a particular time period; extract one or more features from the additional volume forecast data; access historical data to generate a historical data set for one or more historical volume forecasts; extract one or more features from the historical data set; comparing the one or more features extracted from the additional volume forecast data with the one or more features extracted from the historical data set; modify the volume forecast learning model stored in the volume forecasting engine based on the comparison of the one or more features extracted from the additional volume forecast data and the one or more features extracted from the historical data set.

Optionally, in some embodiments of the present disclosure, the volume forecast data comprises one or more of a tracking number, a package activity time stamp, a package manifest time, a service type, a package dimension, a package height, a package width, a package length, or an account number associated with a shipper.

Optionally, in some embodiments of the present disclosure, the one or more features extracted from the one or more volume information units comprise one or more of a residential indicator, a hazardous material indicator, an oversize indicator, a document indicator, a Saturday delivery indicator, a return service indicator, an origin location codes, a set of destination location codes, a package activity time stamp, a set of scanned package dimensions, or a set of manifest package dimensions.

### V. Conclusion

Many modifications and other embodiments of the inventions set forth herein will come to mind to one skilled in the art to which these inventions pertain having the benefit of the teachings presented in the foregoing description and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

What is claimed is:

1. An apparatus for autonomously generating a volume forecast, the apparatus comprising:
a volume forecasting engine configured to:
access one or more volume information units from a volume forecast data management tool, wherein the one or more volume information units comprise volume forecast data, and wherein the volume forecast data comprises one or more of a package received time or package information;
extract one or more features from the volume information units, wherein the one or more features are representative of one or more of the package received time or the package information; and
generate, using a volume forecast learning model and the one or more features, an output comprising the volume forecast for a particular hierarchical level.

2. The apparatus of claim 1, wherein the output further comprises hierarchical level information.

3. The apparatus of claim 1, wherein the output further comprises an indication of one or more statistical errors associated with the volume forecast.

4. The apparatus of claim 3, wherein the volume forecasting engine is further configured to:
generate, using the volume forecast learning model and the one or more features, one or more additional outputs comprising one or more corresponding additional volume forecasts for one or more corresponding additional hierarchical levels,
wherein each of the one or more statistical errors comprises a statistical error for a corresponding one of the generated volume forecasts.

5. The apparatus of claim 2, wherein the hierarchical level information identifies a class of entities addressed by the volume forecast, the class of entities comprising entities having properties associating them with a particular account type, service type, building type, sort type, building identifier, package weight category, package dimension category, other package categorization, shipper, or set of facilities in a shipping process.

6. The apparatus of claim 1, wherein the volume forecast learning model comprises a time-series learning model.

7. The apparatus of claim 6, wherein the time-series learning model comprises an autoregressive integrated moving average model or uses exponential smoothing.

8. The apparatus of claim 1, wherein the volume forecast learning model comprises one or more of a neural network, a random forest based learning model, a gradient boosting based learning model, or multiple adaptive regression splines.

9. The apparatus of claim 1, wherein generating the volume forecast for the particular hierarchical level includes calculating, using the volume forecast learning model, one or more of: a mean absolute percentage error, a weighted mean absolute percentage error, a mean square deviation or a root mean square deviation.

10. The apparatus of claim 1, wherein the volume forecasting engine is further configured to:
receive additional volume forecast data after a particular time period;
extract one or more features from the additional volume forecast data; and
update the volume forecasting engine based on the features extracted from the additional volume forecast data.

11. The apparatus of claim 1, further comprising a training engine configured to:
receive additional volume forecast data after a particular time period;
extract one or more features from the additional volume forecast data;
access historical data to generate a historical data set for one or more historical volume forecasts;
extract one or more features from the historical data set;
compare the one or more features extracted from the additional volume forecast data with the one or more features extracted from the historical data set; and
modify the volume forecast learning model stored in the volume forecasting engine based on the comparison of the one or more features extracted from the additional volume forecast data with the one or more features extracted from the historical data set.

12. The apparatus of claim 1, wherein the volume forecast data comprises one or more of a tracking number, a package activity time stamp, a package manifest time, a service type, a package dimension, a package height, a package width, a package length, or an account number associated with a shipper.

13. The apparatus of claim 1, wherein the one or more features extracted from the one or more volume information units comprise one or more of a residential indicator, a hazardous material indicator, an oversize indicator, a document indicator, a Saturday delivery indicator, a return service indicator, an origin location codes, a set of destination location codes, a package activity time stamp, a set of scanned package dimensions, or a set of manifest package dimensions.

14. A method for autonomously generating a volume forecast, the method comprising:
accessing, using a volume forecasting engine, one or more volume information units from a volume forecast data management tool, wherein the one or more volume information units comprise volume forecast data, and wherein the volume forecast data comprises one or more of package received time or package information;
extracting, using the volume forecasting engine, one or more features from the volume information units, wherein the one or more features are representative of one or more of the package received time or the package information; and
generating, using a volume forecast learning model and the one or more features, an output comprising the volume forecast for a particular hierarchical level.

15. The method of claim 14, wherein the output further comprises hierarchical level information.

16. The method of claim 14, wherein the output further comprises an indication of one or more statistical errors associated with the volume forecast.

17. The method of claim 14, further comprising:
generating, using the volume forecast learning model and the one or more features, one or more additional outputs comprising one or more corresponding additional volume forecasts for one or more corresponding additional hierarchical levels,
wherein each of the one or more statistical errors comprises a statistical error for a corresponding one of the generated volume forecasts.

18. The method of claim 15, wherein the hierarchical level information identifies a class of entities addressed by the volume forecast, the class of entities comprising entities having properties associating them with a particular account type, service type, building type, sort type, building identifier, package weight category, package dimension category, other package categorization, shipper, or set of facilities in a shipping process.

19. The method of claim 14, wherein the volume forecast learning model comprises a time-series learning model.

20. The method of claim 14, wherein the one or more features extracted from the one or more volume information units comprise one or more of a residential indicator, a hazardous material indicator, an oversize indicator, a document indicator, a Saturday delivery indicator, a return service indicator, an origin location codes, a set of destination location codes, a package activity time stamp, a set of scanned package dimensions, or a set of manifest package dimensions.

21. The method of claim 14, further comprising:
receiving, at the volume forecasting engine, additional volume forecast data after a particular time period;
extracting one or more features from the additional volume forecast data; and
updating the volume forecasting engine based on the features extracted from additional volume forecast data.

22. The method of claim 14, further comprising:
receiving additional volume forecast data after a particular time period;
extracting one or more features from the additional volume forecast data;
accessing historical data to generate a historical data set for one or more historical volume forecast;
extracting one or more features from the historical data set;
comparing said one or more features extracted from the additional volume forecast data and said one or more features extracted from the historical data set; and
modify the volume forecast learning model stored in the volume forecasting engine based on the comparison of the one or more features extracted from the additional volume forecast data with the one or more features extracted from the historical data set.

23. A non-transitory computer readable storage medium storing computer-readable program instructions that, when executed, cause a computer to:
access volume forecast data associated with at least one shipment of one or more parcels;
feed the volume forecast data through at least one volume forecast learning model; and
based at least in part on the feeding of the volume forecast data through the at least one volume forecast learning model, predict a first quantity of parcels that will arrive at a destination for a particular time period at a particular hierarchical level, the particular hierarchical level being a category of generated volume forecast.
